(19) United States
(12) Patent Application Publication
(10) Pub. No.: US 2009/0309450 A1
(43) Pub. Date: Dec. 17, 2009

(54) MP-D MACHINES

(75) Inventor: Doris Wilsdorf, Charlottesville, VA (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: KUHLMANN-WILSDORF MOTORS LLC, CHARLOTTESVILLE, VA (US)

(21) Appl. No.: 12/307,487

(22) PCT Filed: Jul. 6, 2007
(86) PCT No.: PCT/US07/15611

§ 371 Date: Apr. 3, 2009

Related U.S. Application Data
(60) Provisional application No. 60/819,499, filed on Jul. 7, 2006.

(51) Int. Cl. H02K 31/00

(52) U.S. Cl. 310/178

(57) ABSTRACT

MP-D Machines are direct current machines of the multipolar type, i.e. machines whose torque is produced in a cylindrical current tube through axially oriented current flow in a plurality of turns between pairs of parallel permanent magnet poles attached to cylindrical concentric magnet tubes. Unlike other multipolar type machines, MP-D machines' magnet tubes comprise a plurality of permanent magnets in the form of continuous circumferential sleeves. The current tube in MP-D machines remains stationary while at least one of the two magnet tubes rotates. MP-D machines may be powered or may generate direct current.

### CROSS-REFERENCES TO RELATED APPLICATIONS

The present application claims priority from U.S. Provisional Patent Application Ser. No. 60/819,499, filed Jul. 7, 2006, entitled “MP-D Machines,” the entire disclosure of which is hereby incorporated herein by reference in its entirety. Further reference is made to U.S. Provisional Patent Application Ser. No. 60/811,946 filed Jun. 8, 2006, entitled “Multipolar Flat Magnets,” and U.S. Provisional Patent Application Ser. No. 60/811,944 filed Jun. 8, 2006, entitled “MP-T Cooling and Lubrication,” which are hereby incorporated herein by reference in their entirety.

### BACKGROUND OF THE INVENTION

“MP-D Machines” are direct current machines of MP (“multipolar”) type, i.e. machines whose torque is produced in a cylindrical “current tube” through axially oriented current flow in a plurality of “turns” between pairs of parallel permanent magnet poles attached to cylindrical concentric magnet tubes. In all previous MP machines, the magnets were arranged into continuous, axially extended rows of alternating radial polarity on an inner and outer magnet tube, and the current tube rotated relatively in a cylindrical gap between these. The magnet pairs generated axially extended “zones” of radial magnetic flux density, B, through which current was led to and fro, parallel to the rotation axis, always such that it generated torque in the same direction. In MP machines with stationary magnet tubes, the current tube rotates and therefore requires electrical brushes. Brushless MP machines are possible with stationary current tube and correspondingly rotating one or more magnet tubes. However, with the described axially extended zones in previous MP machines, only alternating current, albeit with an arbitrary number of phases, can be employed in the motor mode or generated in the generator mode.

### BRIEF SUMMARY OF THE INVENTION

The present invention of direct current MP-D machines employs the same basic principles but with permanent magnets attached to magnet tubes in the form of continuous circumferential “sleeves.” Two basic types are described, dubbed MP-D I and MP-D II machines, depending on whether they comprise only one magnet tube (either inside or outside of the current tube) or two magnet tubes (in the gap between which the current tube resides). There are two choices for these, i.e. that neighboring sleeves in the current tube and the correlated neighboring magnet sleeves on the magnet tubes have the same or alternating polarity. In case of same polarity, the thickness of required magnetic flux return material rises essentially linearly with axial sleeve length. Consequently, for MP-D machines of acceptably high power density, the axial length of sleeves is restricted. Therefore, gaps to accommodate flux return are required between neighboring sleeve pairs of same polarity. However, on traversing flux return gaps, a current passing along multiple sleeve pairs of same polarity would encounter flux lines of opposite direction and therefore would generate opposing torque, for total zero torque in a machine.

The same need for flux return gaps does not exist for sleeve pairs of alternating polarity because each pair provides flux return for its neighbors. However, an axial current passing along multiple sleeve pairs of alternating polarity would generate torque of alternating direction, i.e. zero torque or voltage for an even number of sleeve pairs, and torque or voltage as of a single sleeve pair for an odd number of sleeve pairs, for motors and generators, respectively. Hence for effective MP machines with sleeves of alternating polarity, gaps must be left between sleeves in order to lead the current between sleeve pairs in paths that avoid counter torque.

It follows that MP machines both with sleeve pairs of unidirectional as well as alternating polarity, require gaps between neighboring sleeve pairs, one to provide flux returns and the other to provide suitable current paths. Moreover, in both types, crossings between currents and flux return paths are unavoidable that involve extra electrical machine resistance and/or counter torque. Two possibilities exist for minimizing these undesirable effects of current passages across flux return paths. The first is direct transits. Machines using this method are identified with the label t for “transits”; e.g. MP-D II t designates a machine with two magnet tubes that comprises current transits across flux return paths. This choice involves a significantly increased electrical machine resistance, mainly because magnet flux return material (typically iron-silicon) has an electric resistivity of ρ_{F}≅10⁻⁷ Ωm, as compared to ρ≅2×10⁻⁸ Ωm for the conductor material. Typically the latter is copper including insulating adhesive boundaries that are variously used for machine construction, for defining current paths and/or for the use of compacted twisted Litz wires IF needed for the suppression of eddy currents (which is not expected to be the case).

Alternatively, flux returns may be structured such that high-resistance flux return material bypasses the current path or paths. This may be done by interleaving current paths with parallel layers of flux return material. Also this method engenders extra ohmic machine resistance because it requires current paths that are lengthened and/or narrowed. Machines with this feature are identified with the label b for “bypassing”; e.g. MP-D I b designates a machine with one magnet tube in which flux returns bypass current paths rather than intersecting them.

It may be added here that, in the following, throughout, uniform thickness of permanent magnets and of the flux return material backing them has been assumed, namely Hₘ for magnet thickness and L_{b} for the thickness of the flux return material backing them. In fact, as far as magnetic flux is concerned, flux return material that backs permanent magnets could have graded thickness, theoretically from vanishingly thin at the midlines to thickness L_{b} at the ends of magnets, i.e at the edges of the gaps between neighboring magnets. While such grading can save weight, it is of dubious or no value because flux return material serves a dual function by also providing mechanical strength. Besides, grading would probably cause increased production costs. The question of thickness grading is not addressed herein. Even so, especially in large machines, grading of magnet as well as of flux return material thickness could be useful and may be important in future technological MP-D machines, especially of large sizes.

Additionally to the above features, and of fundamental importance, MP-D machines comprise radially extended, mutually electrically insulated “leaves” that each comprise at least one current “turn.” Typically, leaves are connected in series. The induced voltage of “in series” leaves is additive in both the motor and generator mode. By supplying pairs of terminals to the outside between different numbers of leaves, an MP-D machine may be divided into independent machines that may be used as motors, generators and/or transformers, in the same manner as previously described for other MP machine types (compare “Multipolar Machines”—Doris Kuhlmann-Wilsdorf, Patent Application PCT/US03/21298 filed 8 Jul. 2003; “Multipolar-Plus Machine—Multipolar Machines with Reduced Numbers of Brushes,” Doris Kuhlmann-Wilsdorf, Patent Application PCT/US05/23245 filed 29 Jun. 2005; “MP-A and MP-T Machines, Multipolar Machines for Alternating and Three-Phase Currents,” Doris Kuhlmann-Wilsdorf, Patent Application PCT/US05/30186 filed 24 Aug. 2005; “Multipolar Machines—Improvements,” Doris Kuhlmann-Wilsdorf, patent application, Filed 23 Sep., 2005). Continuous current paths between successive turns are provided for by means of “current return end rings.”

The performance and power density of MP-D machines sensitively depends on the specific magnet dimensions chosen. These have not as yet been optimized. At this point, “Case 3A” (see below) among a number of different magnet pair arrangements that were previously examined via finite element analysis is found to be the best for MP-D machines, and this has been assumed throughout. Tables are provided that summarize the forecast performance of MP-D I and MP-D II machines. At present MP-D II b machines appear to be the most effective. Careful finite element analysis is recommended for optimization.

The advantages of MP-D machines include the following: They are homopolar, with neither the magnet nor the current geometry changing during machine operation, and thus are expected to be extremely quiet, acoustically as well as electronically. Next, they should be very easily controlled, in that they will draw a current commensurate with the torque resisting their motion or the power accepted by users, as the case may be, and that they will rotate at a speed proportional to the voltage at which that current is supplied to a motor, or conversely will provide a voltage proportional to the rate of rotation applied to MP-D generators.

Further, like all MP machines, so also MP-D machines may be scaled up to indefinitely large sizes. This feature arises because they are readily cooled and the magnets in them will not be large even in very powerful machines. An additional advantage, not shared by other MP machines, is that they may be scaled down to well below ˜10 hp that in the past has been the estimated practical lower size limit of MP machines. At this point MP-D motors and generators well below 100 watt are believed to be feasible and commercially attractive.

As a critical further feature, the number of current “turns” in MP-D machines may be selected within a wider range than possible in previous MP machine types. As a result, the voltage of MP-D machines may be more freely chosen than of other MP machines, even at low rotation speeds, and they may be made quite short, i.e. they are suitable for in-wheel or in-hub motors.

### BRIEF SUMMARY OF THE DRAWINGS

FIG. 1: A schematic illustration of the detail of one “slice” in the wall of an MP-D I t machine in length-wise cross section.

FIG. 2: A schematic illustration of the lengthwise cross section through an MP-D I t machine comprising units as in FIG. 1.

FIG. 3: A schematic illustration of a partial cross section through an MP-D I t machine in position A-A of FIG. 2.

FIG. 4: Schematic illustrations of the end-on (FIG. 4A) and top view (FIG. 4B) of MP-D I machines as in FIGS. 1 to 3.

FIG. 5: Illustration of the cross section through part of an MP-D I t machine including a cooling channel.

FIG. 6: A schematic illustration of the detail of a “slice” in the wall of an MP-D II machine in length-wise cross section,

FIG. 7: Illustration of overlapping to- and fro-current paths between neighboring inner and outer sections.

FIG. 8: A schematic illustration of the lengthwise cross section through an MP-D II machine.

FIG. 9: A schematic illustration of the partial cross section through an MP-D II machine in position AA of FIG. 8.

FIG. 10: A schematic illustration of the basic geometry by means of which the flux densities have been assessed.

FIG. 11: A graph of the morphology of magnets and field lines for Case 1A.

FIG. 12: A graph of the morphology of magnets and field lines for Case 3A.

FIG. 13: A schematic illustration of the expected flux density distribution, B, in an MP-D I t machine.

FIG. 14: A schematic illustration of the expected flux density distribution, B, in an MP-D II machine.

FIG. 15: A schematic illustration of the wall detail and partial cross sections of MP-D I b machine in the style of FIG. 1.

FIG. 16: A schematic illustration of the top view onto torque-producing inner sections 2 of current tube 206_{T} (flattened).

FIG. 17: A schematic illustration of the flux distribution and current path in part of a slice of an MP-D II b machine.

### DETAILED DESCRIPTION OF THE INVENTION

The following explanations will clarify the construction of MP-D machines in conjunction with figures and tables.

### Basic Construction of MP-D I Machines

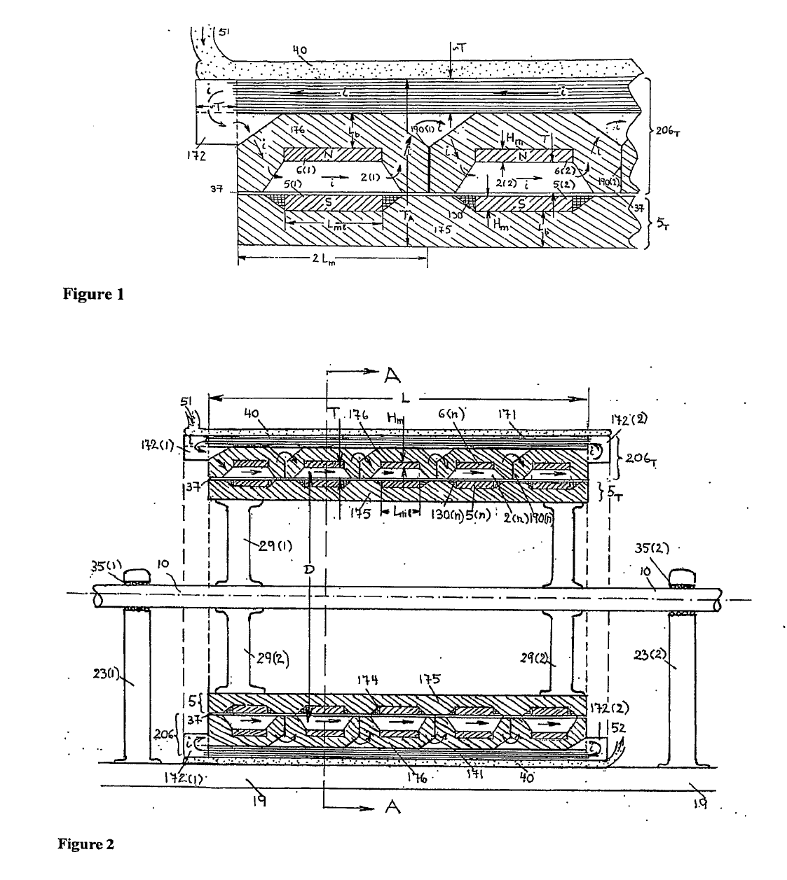

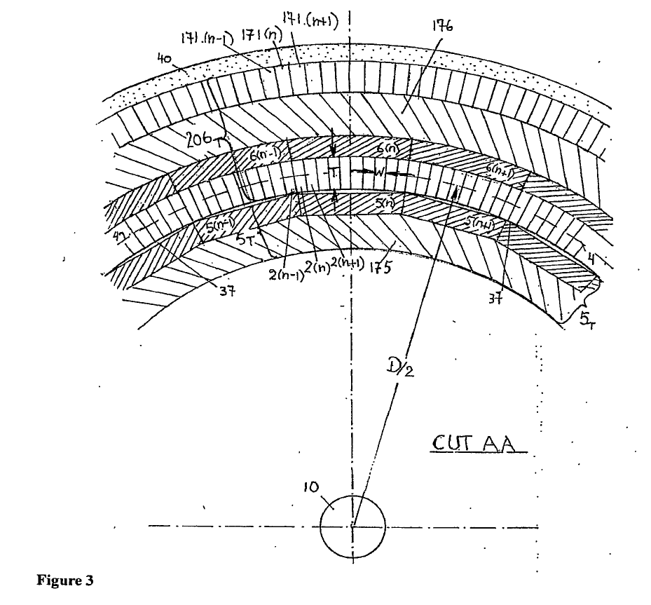

MP-D machines may be best understood in terms of continuous “sleeves” of magnets that are subdivided into radial “leaves,” as already indicated above. For the case of an MP-D I machine, comprising a stationary current tube (stator) 206_{T} and inner magnet tube 5_{T}, the lengthwise cross sections of two sleeves are shown in FIG. 1, and their assembly into a machine in FIG. 2. Herein, the torque is provided by several to many “turns” of current i each turn passing within any one leaf of circumferential width w, between opposing pairs of permanent magnets, e.g. 5(1) and 6(1) and 5(2) and 6(2). As indicated in FIGS. 2 and 3, magnets 5(n) and 6(n) are arranged in continuous pairs of concentric sleeves that encircle the inner magnet tube 5_{T} for a full 360° and are similarly aligned inside of the current tube 206_{T}. On the two sides, the magnets are embedded in the flux return materials 175 and 176 (presumably silicon iron).

In leading the current across the distances between adjoining current carrying, torque producing sections 2(n) and 2(n+1), i.e. in FIG. 1 from section 2(1) between magnets 5(1) and 6(1) to section 2(2) between magnets 5(2) and 6(2), areas of inverted flux density, i.e.—B, must be avoided as much as possible, since these would generate torque opposed to the intended machine torque. To this end, in FIGS. 1 to 3, the current is detoured away from interface 37 between rotor 5_{T} and stator 206_{T}, and back, as indicated by the arrows labeled “i,” namely via current barriers 190. After traversing the length, L, of the current tube 206_{T}, the current is led back to the next leaf via current return 171.

Where needed for suppression of eddy currents, stator 206_{T} may be made of compacted mutually insulated and mildly twisted Litz wire cables. However, since MP-D machines are homopolar with direct current, using Litz cables in them will almost certainly be unnecessary while all previous MP machines required measures against eddy currents. Another considerable advantage of MP-D I versus other MP machines is that they involve a single moving interface 37 between current tube 206_{T} and, typically, inner magnet tube 5_{T}. Optionally, a rotating outer magnet tube could be used, instead. In fact, construction details provided herein are largely optional and are presented by way of example, only.

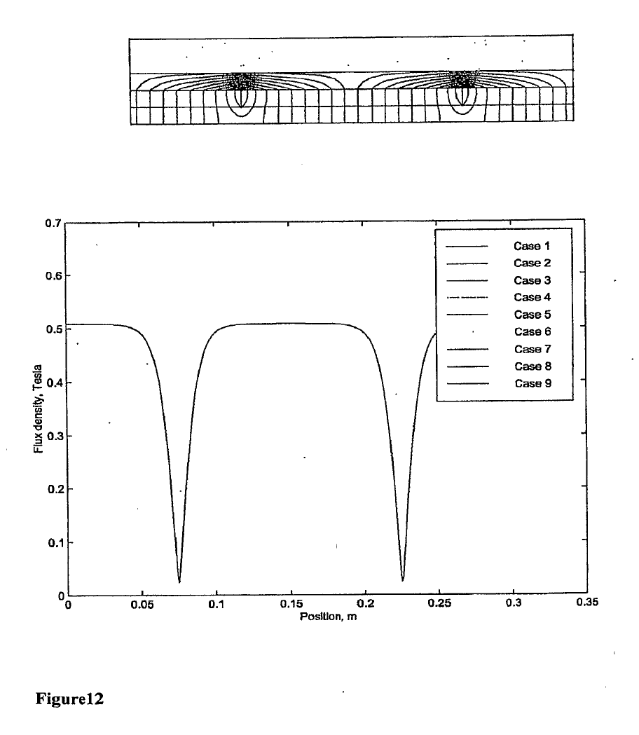

Beyond aiming to avoid counter torque, the ohmic resistance on the current path is to be minimized. In FIGS. 1 and 2, the outlines of flux returns 175 and 176 and non-magnetic insulating inserts 130 next to magnets 5(n) are designed for this twin goal. However, finite element analysis is recommended to seek out the best possible morphology. Specifically, axially lengthened sleeves, i.e. increased Lₘₗ, require wider flux return layers, i.e. increased L_{b}, with commensurate increase of both machine weight and current path resistance per transit, but they reduce the number of transits. The magnet morphology in FIGS. 1, 2 and 5 is based on “Case 1A” (see FIG. 11), with a relatively short axial sleeve length Lₘₗ and large number of transits across flux return material 176 with correspondingly large ohmic machine resistance. Numerical evaluation shows Case 3A (see FIG. 12) to be favorable for MP-D machines, while Case 1A is excellent for MP-T machines (Multipolar Three Phase machines). Thus Case 3A, or a still to be determined morphology, will probably be used for future MP-D machines.

As already mentioned and shown in FIG. 3, the stator, i.e. the current tube 206_{T}, is segmented into mutually electrically insulated radial “leaves,” of width w or w* at the current path mid-line 4. In MP-D I machines, each leaf accommodates a current “turn” as follows: Let the current enter leaf 1 of the machine via current return end ring 172(1) at left in FIG. 2. After successively passing through all of current-carrying sections 2(n) of leaf 1, it will reach the end of current tube 206_{T}, where it will pass through current return end ring 172(2) into leaf 1 of the current return 171 and on to current return ring 172(1). Before reaching 172(1) or within it, the current is guided to leaf 2, to begin another “turn,” and from there on through leaf 3 and on until it finally emerges at the last leaf N.

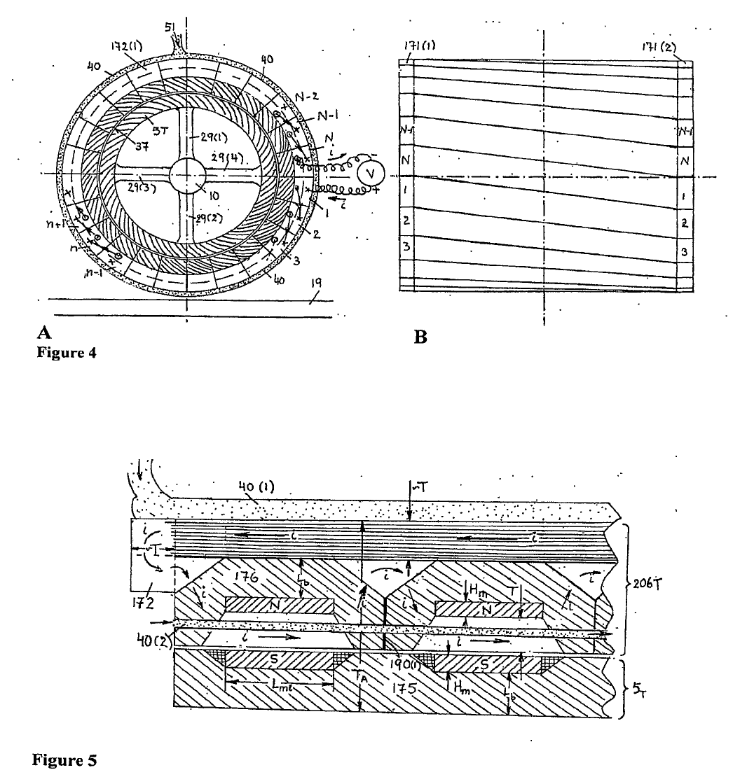

FIG. 4 clarifies two different geometries by which the transfer from one leaf to the next may be accomplished. The first is depicted in FIG. 4A. It is an end view of the machine and shows current return end ring 172(1) divided into two mutually insulated rings, an outer and inner ring, as also indicated in FIGS. 1 and 2,—besides of course being divided into mutually insulated “leaves” like the rest of the current tube 206. Herein the leaves of the outer ring are in mutually insulated electrical contact with the correlated leaves in current return 171, while the leaves in the inner ring are similarly in contact with the neighboring leaf of current paths 2(n). However, within ring 172(1), between the outer and inner part, connection is made between neighboring leaves. Thereby the current consecutively passes through all leaves, from #1 to N, for N “turns,” as seen in FIG. 4A. Alternatively, as illustrated in FIG. 4B, the leaves of current return 171 may slightly spiral, to the effect of tangentially offsetting the left and right ends of the leaves by leaf width of w.

With a current path mid-line (label 4) diameter of D, and leaf width w at that line, as shown in FIG. 3, the number of turns in a complete circuit will be N=πD/w. Evidently, N can be a sizeable number, depending on the values of D and w. Specifically, w=1 mm would appear to be a reasonable lower limit. Hence even a small machine of D=10 cm could have hundred turns. More commonly, one will think in terms of, say, w=1 cm thick leaves, and a numbers of turns, N, in the tens. The important consideration here is the possibility of generating sizeable voltages, since with all “turns” in series, the machine voltage will be V_{M}=NV₁ where V₁ is the voltage per turn. Everywhere except at the terminals, the voltage between neighboring leaves is only V_{M} divided by the number of “in series” leaves, but the leaves connected between the “in” and “out” terminals are at the voltage difference V_{M}. For safety against leak currents of sparking, those are preferably separated by one or two “empty” or “idle” leaves.

As already discussed, FIG. 4B depicts a simpler method for transitioning currents from turn to turn, namely through inclining the current paths in current return 171 relative to the machine axis. In that case, current return end ring 172(1) need not be subdivided into an inner and outer ring (although still requiring division into N leaves for N turns). Instead end ring 172(1) needs simply to connect the current return leaves to the underlying “turn” leaves, in the same manner as current return end ring 172(2) is expected to do all the time.

### Cooling

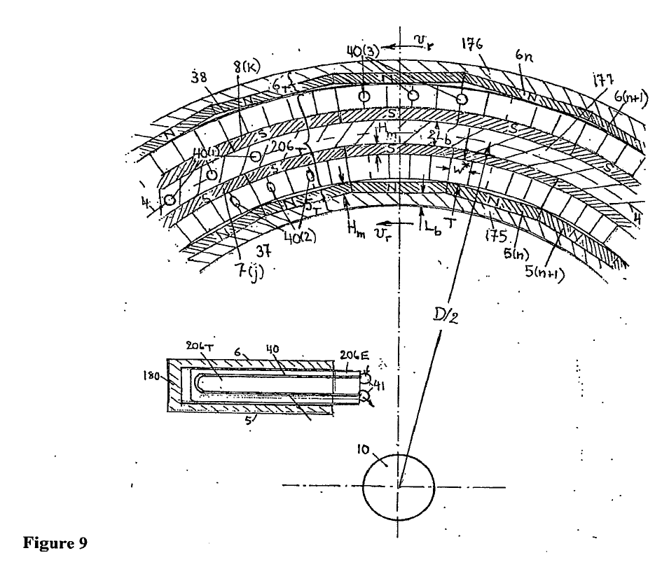

Two cooling scenarios are envisaged. The first, namely through a cooling “jacket,” is indicated in the preceding figures. This is liable to be quite effective but applicable only to MP-D I machines. Alternatively, cooling channels 40 within current paths 2(n), of which various choices, among an almost unlimited variety in terms of sizes, shapes and placement, are indicated in FIG. 5 for MP-D I machines and in FIG. 9 for MP-D II machines, may be employed. This method has been analyzed in the recent provisional patent application “MP-T Cooling and Lubrication” (Submitted Jun. 8, 2006). Cooling of MP-T Machines by this method, with water or other suitable fluid cooling mediums, when one quarter of the current path cross section is dedicated to cooling channels, was found to be amply sufficient for every conceivable case. The increased internal electrical resistance of MP-D machines and consequent increased Joule heat will make cooling of these somewhat more demanding. Even so, the safety margin for MP-T machines is so large that any and all MP-D machines may presumably also be readily cooled by this method;—and certainly will be so by still increasing the cooling channel area somewhat.

### Lubrication

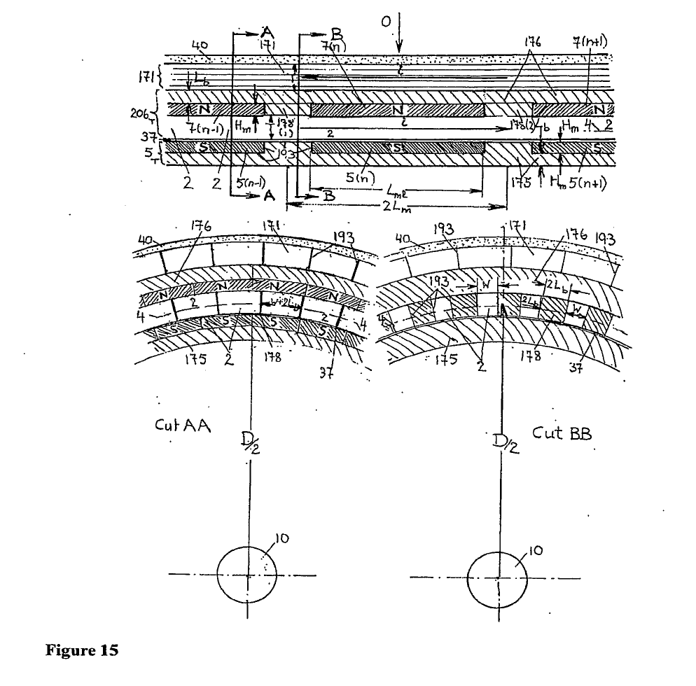

FIG. 3, as also FIG. 15; assumes a fit between rotor 5_{T} and current tube 206_{T} at sliding interface 37 via flat magnets 5(n), and FIG. 9 envisages that same construction for interfaces 37 and 38 between current tube 206 and magnet tubes 5_{T} and 6_{T}, respectively. This construction has been discussed in the already mentioned Jun. 8, 2006 disclosure “MP-T Cooling and Lubrication.” It is believed to be effective through trapping lubricant in multiple shallow, wedge-like spaces between magnets and smooth, circularly cylindrical current tube 206_{T}, while at the same time constantly distributing lubricant over the interfaces and suppressing “chatter.” Choice and mode of injecting lubricant should preferably follow accepted industrial practice for lubrication, from case to case depending on size, speed, materials and ambient temperature. For reduction of undue interfacial stresses due to differential thermal expansion, this construction is believed to require ˜0.5 mm gaps between neighboring magnets and about 0.06% of D radial expansion space between current tube 206_{T} and magnet tubes 5_{T} and 6_{T}.

### Basic Construction of MP-D II t Machines

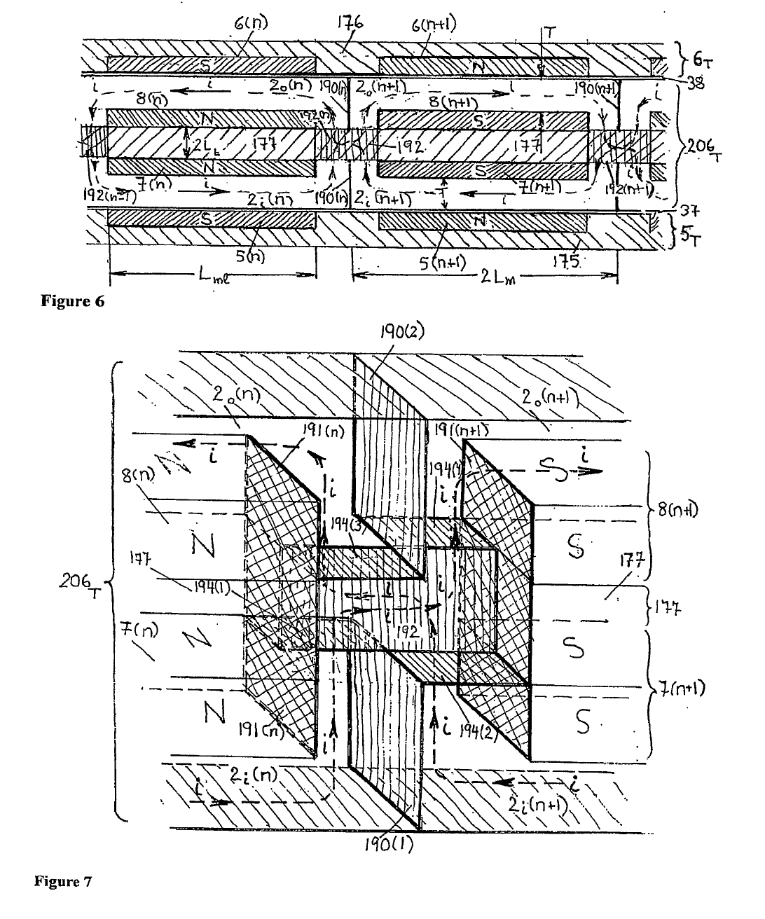

MP-D II machines are designed to eliminate current return 171, because it contributes to the machine weight as well as electrical resistance, without contributing to the machine torque. In MP-D II t machines of the construction illustrated in FIGS. 6 to 8, therefore, (i) the polarity of sleeves alternates, (ii) current return 171 is replaced by adding to current tube 206_{T} the mirror image across its mid-line surface 4 of magnets 7(n) in the form of magnets 8(n) and doubling the width of flux return material 177 between them, (iii) magnet tube 6_{T} is added as the mirror image across mid-line surface 4 of magnet tube 5_{T}, and (iv) the current is made to meander between inside and outside current carrying, torque-producing sections 2ᵢ(n) and 2ₒ(n) so as to produce torque in the same direction everywhere.

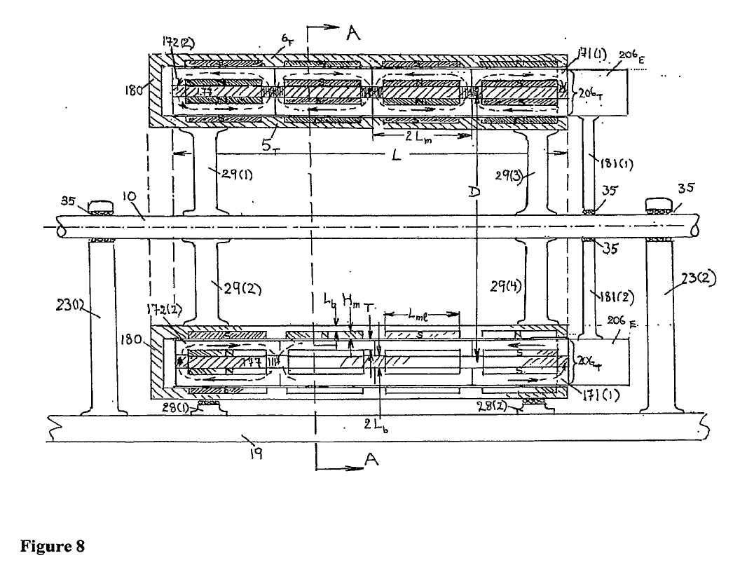

Disregarding for the moment the velocity difference between the two sides on account of their different cylindrical radii, this construction of MP-D II machines doubles the machine voltage. This advantage is bought at the expense of a more complex machine construction as indicated in FIG. 8. In essence the morphology of MP-D II machines represents the inner and outer wall of a double walled cup formed by magnet tubes 5_{T} and 6_{T}, between which current tube 206_{T} is inserted like an inverted cup. Thus concentric magnet tubes, 5_{T} and 6_{T}, enclose current tube 206_{T} from the inside and outside, and the wall width of 206_{T} is increased to accommodate an additional pair of magnet sleeves and extra flux return material thickness while taking away current return 171 and achieving two instead of one current carrying/torque producing sliding interfaces, i.e. 37 and 38. Hence, also, a single leaf will accommodate two current turns, one from left to right and one from right to left.

Basically, the above is the same geometry as of previous MP machines but with one complication. Namely, in previous MP machines the relative angular alignment of inner and outer magnet tubes, 5_{T} and 6_{T}, was maintained automatically on account of their alternating magnetic polarity that provides periodic deep energy wells, namely in any configuration of pair-wise magnet alignment between magnet tubes 5_{T} and 6_{T}. In other MP machines, including MP-A and MP-T machines, it is therefore unnecessary to mechanically fix the angular position of magnet tube 6_{T} relative to 5_{T} and vice versa. This is not the case for MP-D machines based on magnet sleeves, though, since for these all radial alignments are equivalent.

MP-D machines therefore may require a firm mechanical connection between magnet tubes 6_{T} relative to 5_{T}, such as part 180 in FIG. 8. Albeit, such connection prevents non-rotating physical access to current tube 206_{T} from that machine end and prevents mechanical support of current tube 206_{T} on and to axle 10 anywhere along the whole the length of magnet tubes 5_{T} and 6_{T}, although it does permit such centering and supports of magnets tubes 5_{T} and 6_{T} on and to axle 10 Still, this construction is believed to enable smooth, low-friction rotation of the rigidly connected magnet tubes 5_{T} and 6_{T} about stator 206_{T} even for relatively long machines. It is proposed to facilitate such smooth rotation through the use of flat magnets in the magnet sleeves on both sides of the circular cylindrical current tube 206_{T}, as indicated in FIG. 8, and similarly at the single interface in MP-D I machines (see FIGS. 3 and 15) whose features have already been outlined in section “Lubrication” above.

Another difference between MP-D I t and MP-D II t machines of the type in FIG. 8 is that the current must repeatedly transit from the inner to the outer side of the current tube, i.e. between segments 2ᵢ and 2ₒ, and thus must repeatedly cross flux return material 177 at the same time as it crosses the gap between adjoining sleeves. Moreover, as seen from FIGS. 6 and 8, each leaf comprises currents from left to right and from right to left, which two directions must pass each other while maintaining electrical insulation. Various morphologies to accomplish this goal are doubtlessly possible. A particular solution is depicted in FIG. 7. FIG. 9 shows a cross section of an MP-D II t machine through a double pair of sleeves, i.e. outside of any “cross-over transits.” In FIGS. 6 and 8 those transits are indicated by vertical lines and label 190 in reference to the axially oriented barriers that separate the two bypassing current paths. A further MP-D II machine type is described after first discussing flux return morphology.

### Optimizing Morphology of Current Paths and Flux Returns

### Available Modeling Data

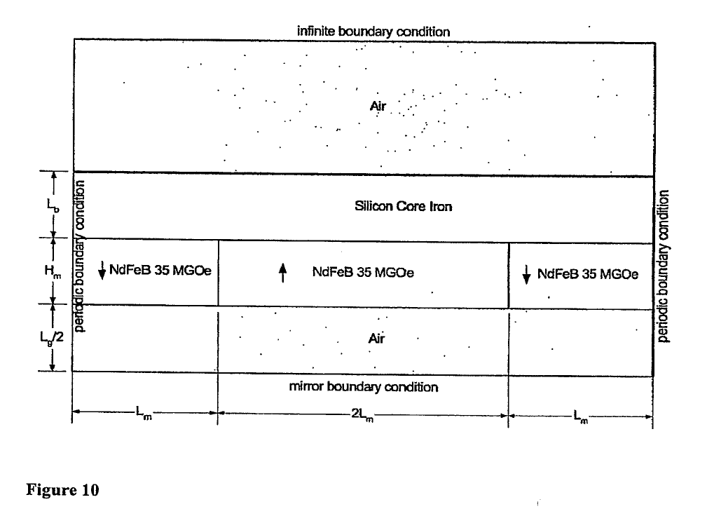

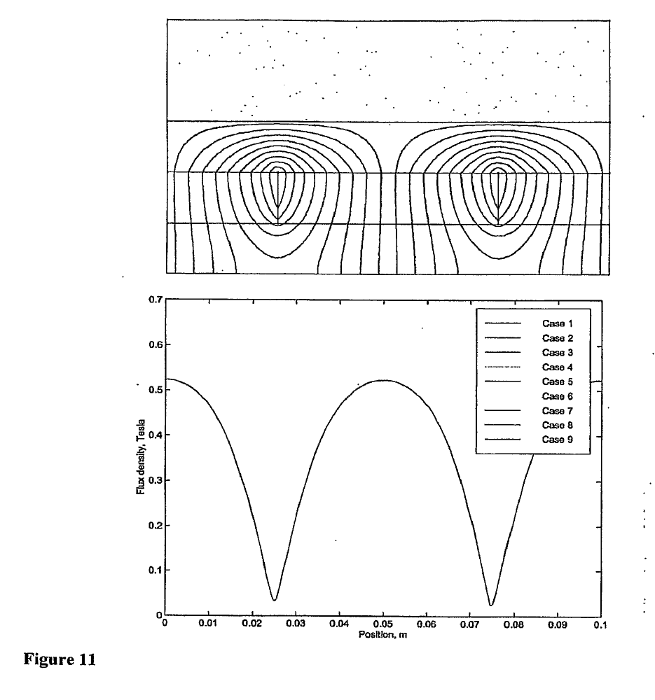

As yet, no detailed modeling of the flux distribution about magnet arrangements as considered herein are available. In lieu thereof, use has been made of finite element modeling of closely spaced flat magnets that underlay the already cited provisional patent application “Multipolar Flat Magnets” of Jun. 8, 2006, namely by Prof. Eric H. Maslen of the University of Virginia, Charlottesville. FIGS. 10 to 12 present the essential results of that work, wherein FIG. 10 presents the basic geometry including the definitions of the salient parameters:

Hₘ=Thickness of permanent magnets,
2Lₘ=Periodicity distance between magnets independent of direction of polarity,
L_{b}=Thickness of flux return material backing permanent magnets,
L_{g}=Gap width between opposing magnet pairs.
Further, FIGS. 11 and 12 present the geometry of the magnetic flux lines for Cases 1A and 3A, and the magnetic flux density on the mid-plane between the magnets for these cases, i.e. what in the present paper is the mid-plane of current carrying, torque-producing sections 2(n), or 2ᵢ(n) and 2ₒ(n), respectively. As seen in FIG. 10, the calculations were performed for silicon-iron as flux return material and NdFeB 35 MGOe material. However, in preferred embodiments, NdFeB 45 MGOe material will be used in MP-D machines. Therefore, in numerical evaluations in the Tables below, the magnetic flux density values, B [tesla], in the diagrams of FIGS. 11 and 12 below, are multiplied with (45/35)^{1/2}=1.13. Further, instead of an air gap, the space between opposing magnet poles is in MP-D machines filled with sections 2(n), i.e. commonly copper. This difference hardly affects the data.

The various cases computed in this study are labeled “A” in distinction from Cases “B” of a subsequent study. It is presumed that the same values of flux density B [tesla] will be obtained if the dimensions are scaled as, say, Hₘ=KHₘₒ, with K being the same for all, Hₘ, Lₘ, L_{b} and L_{g} for any one case. The specific data are as follows:

Case 1 A: Hₘₒ=1.25 cm, L_{bo}=1.25 cm; 2Lₘₒ=5.0 cm and L_{go}=2.5 cm=Tₒ
Case 3 A: Hₘₒ=1.25 cm, L_{bo}=1.25 cm; 2Lₘₒ=15.0 cm and L_{go}=2.5 cm=Tₒ.

While for the case of MP-T machines, the “Case 1A” arrangement was found to be the best, and this was, semi-quantitatively, used in FIGS. 1, 2 and 5, closer investigation showed, instead, that Case 3A is considerably superior for use in MP-D machines. Even so, it is most unlikely that, with relatively so few data available, Case 3A should happen to be the absolute best. Additional numerical analysis is therefore highly likely to reveal still improved results compared to Case 3A, and such analysis is strongly recommended to be done for future actual MP-D machine construction.

### Approximate Flux Line Patterns of MP-D I and MP-D II Machines and Resulting Differences

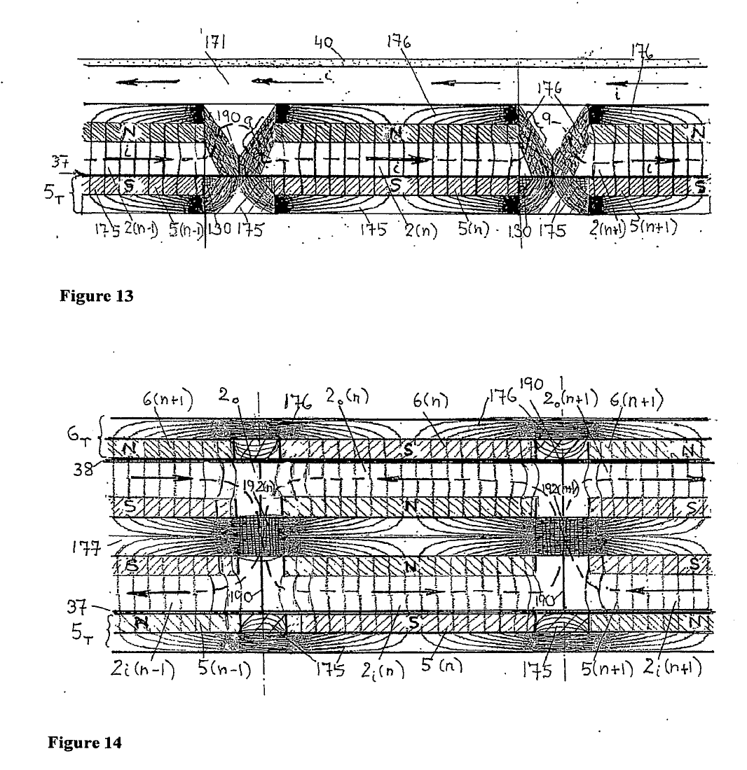

Based on FIG. 12 pertaining to Case 3A of closely spaced flat magnets of alternating polarity, flux line patterns have been constructed for MP-D I and II machines with Case 3A magnets but including gaps between them. Herein it was assumed that the same thickness of flux return material, namely here of L_{b}=Hₘ=K×1.25 cm thickness, would serve as flux returns also to bridge distances between magnets, and do so without significant loss of magnetic flux density, B, in the torque-producing sections 2(n) of current tube 206_{T}. FIGS. 13, 14 and 17 show the results for length-wise cuts through part of an MP-D I t, an MP-D II t and an MP-D II b wall section, respectively.

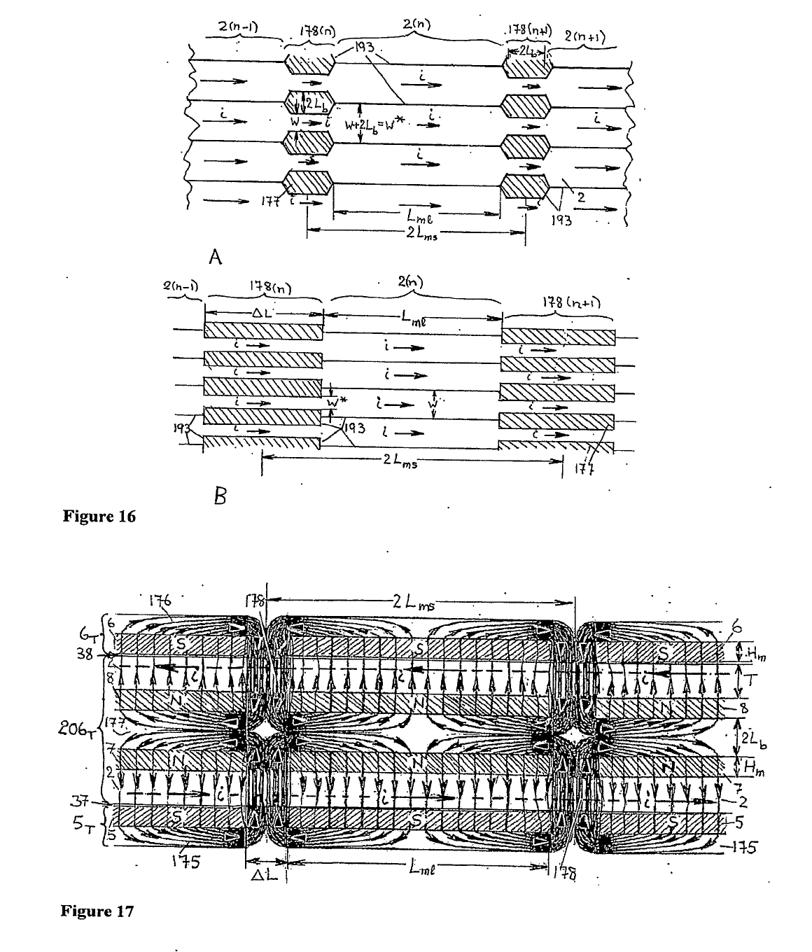

From these patterns it became clear that the internal resistance for MP-D II b machines as in FIG. 17, i.e. with the magnetic polarization of all sleeves in the same orientation, and currents parallel to interfaces 37 and 38 everywhere, could be made to have the smallest resistance of all MP-D machines, namely by the use of flux return material sections interleaved between parallel current paths as illustrated in FIG. 16. Herein two different, although closely related cases were considered. Firstly (FIG. 16 A) that the flux return material 177 would penetrate the current paths at its normal axial width of 2L_{b}, between current paths of locally reduced thickness width w but overall increased leaf thickness, w*. While this is a feasible option, a better choice was found to be axially extended sections of flux return material but narrowed so as to occupy their normal cross sectional area, as in FIG. 16B, including between them narrowed sections of current path width w* that link leaves of their normal thickness w.

The path resistance in the second case depends on w*, the width of the narrowed path width between layers of flux return material as follows: If w*=xw, leaving (1−x)w width for the flux return material per leaf, and if the flux return area per leaf shall be unchanged, then ΔL=2L_{b}/(1−x). The electrical resistance of the narrowed stretch of current path is in that case ρΔL/xTw=ρ2L_{b}/[x(1−x)Tw]. We find its minimum by differentiation and setting to zero, namely at x=½. Thus the optimum value of w* is w/2 with length ΔL=4L_{b}. With these values, the electrical resistance of unit 2(n) consisting of a L_{m/}long current path of cross section wT, plus length ΔL=4L_{b} of cross section w*T=wT/2, is R_{2(n)C}=ρ[Lₘ/wT+8L_{b}/wT], to be compared with the normal electrical resistance if there were no intervening flux return material of R₂₍ₙ₎ₒ=ρ[L_{m/}/wT+2L_{b}/wT].

Numerically, for Case 3A, with L_{m/}=12Hₘ=12L_{b}, thus, the unit length of magnet plus interval between magnets, i.e. L_{m/}+ΔL, is increased from (12+2)L_{b} to (12+4)L_{b}, i.e. by a factor of 16/14=1.14, and the path resistance is increased from R₂₍ₙ₎ₒ=ρ[(12+2)Hₘ/w T] to R_{2(n)C}=ρ[L_{m/}/wT+8L_{b}/wT]=ρ[(12+8)Hₘ/wT, i.e. by a factor of R_{2(n)C}/R₂₍ₙ₎ₒ=20/14=1.43. These are very reasonably low numbers. By way of comparison, transits as in Figure would involve at least a factor of 2.3 increase of electrical resistance per 2(n) section unit. Correspondingly, it is concluded that in terms of voltage and electrical resistance, i.e. ohmic loss [symbol] , machines of type MP-D II b will be the most successful.

### Approximate Parametric Relationships for MP-D II Machine Operation

For an approximate numerical analysis of MP-D machine operation, the following symbols will be used:

_{D}A_{Z}=wKTₒ=cross section of current flow in individual turn in MP-D machine,

_{T}A_{Z}=K²LₘₒTₒ/N_{T}=cross section of current flow in individual turn in MP-T machine,

B=Magnetic flux normal to current,

C_{M}=Materials Cost of machine=$40×mₘ+$10×(m_{M}−mₘ),

D=Diameter at current path midline (4),

d≅8000 kg/m³=Mechanical density of machine materials,

f=Fraction of current tube length occupied by magnets (equals 1 for MP-T machines),

F_{L}=Lorentz force per leaf,

Hₘ=KHₘₒ=Thickness of permanent magnets,

i=current through individual turn=jA_{Z},

i_{M}=Machine current,

j=Current density,

K=Scaling factor for magnet assembly dimensions,

L=Length of current tube,

L_{b}=KL_{bo}=Radial thickness of flux return material,

Lₘ=KLₘₒ=Width of permanent magnets (i.e. “zone width”) in MP-T machines,

L_{m/}=K L_{m/o}=Length of permanent magnets in axial direction (i.e. width of “sleeves”),

Lₘₛ=Half-width of periodicity distance in MP-D machines,

[symbol] =Ohmic loss V_{Ω1}V₁.

M_{M}=W_{M}/2πν=Machine torque,

N_{DL}=πD/w=Number of leaves in MP-D machine,

N_{S}=L/(L_{m/}+Δ)=fL/K L_{m/o}=Number of sleeves per leaf,

N_{T}=Number of layers in current path material of MP-T machines,

N_{TT}=N_{T}N_{Z}=Number of turns in MP-T machines,

N_{U}=Number of parallel units into which machine is divided,

N_{Z}=πD/2Lₘ=πD/2KLₘₒ=Number of zones,

R₁=Ohmic resistance per “turn,”

T=KTₒ=Radial thickness of current path material,

vᵣ=πDν=(π/60)Dωᵣₚₘ=Relative velocity between current and permanent magnets,

V_{M}=Machine voltage,

V₁=Induced voltage per turn,

V_{Ω1}=Ohmic voltage in current path per turn,

w=Width of slice available for current passage,

w*=Geometrical width of slice including magnetic flux bypass material,

ΔL≧2L_{b}=Axial length of section of MP-D machines occupied by flux return material,

ν=ωᵣₚₘ/60=Rotation rate in Hertz,

ρ≅2×10⁻⁸ Ωm=Electrical resistivity in active part of current path,

ωᵣₚₘ=60ν=Rotation rate in rpm.

Expected performance characteristics for MP-D I t and MP-D II t machines, in comparison with MP-T machines, are given in Table I below. Since for future technological applications both MP-D I b and MP-D II b machines are liable to be more successful than “t” machines, they are considered more explicitly below as follows (identifying MP-D and MP-T machines, for comparison purposes, with subscripts D and T, respectively).

### Characteristics of MP-D II b Machines

The Lorentz force at current density j in 2(n) sections of MP-D II b machines is, for one turn,

F₁=j_{D}A_{Z}fLB=jwKTₒfL_{D}B (1)

where f=L_{m/}/(L_{m/}+Δ). Consequently, with two turns per leaf, the Lorentz force per leaf will be

F_{L}=2F₁=2wKTₒfL_{D}Bj (2)

and with N_{DL}=πD/w leaves per machine, the resulting machine torque will be

_{D}M_{M}=(D/2)N_{DL}F_{L}=f πD²KTₒL_{D}Bj. (3)

The corresponding expression for MP-T machines is

_{T}M_{M}=(π/4)D²KTₒL_{T}Bj (4)

wherein _{T}B may be slightly smaller (namely ˜0.56 tesla) than _{D}B˜0.58 tesla on account of the use of Case 1A or similar magnet arrangement in MP-T machines in contrast to the Case 3A or similar arrangement in MP-D machines. In any event, the machine torque is a direct function of the machine current and current tube/magnet geometry, independent of the rotation rate. At same current density, then, according to (3) and (4),

_{D}M_{M/T}M_{M}=4f_{D}B/_{T}B. (5)

Since f=L_{m/}/(L_{m/}+ΔL) is expected to be f≅75% (i.e. 12Hₘ in 16Hₘ, see section “Approximate Flux Line Patterns . . . ” above) at same current density, MP-D II machines thus develop a three times larger torque. However, on account of narrowed sections of width w*=w/2 (see FIG. 16), only 50% of the current density in MP-T machines may be achievable. Even so, an advantage of more than 50% is liable to remain. This is due to, firstly, to the fact that leaves occupy the whole current tube circumference, while zones occupy only one half of it, and secondly because each MP-D leaf accommodates two turns instead of one in MP-T machines, compensated by the fact that zones are continuous but sleeves need gaps between them.

From eq. 4 follows for the machine power

_{D}W_{M}=_{D}M_{M}(2πωᵣₚₘ/60) (6)

i.e. for same machine speed

_{D}W_{M}/_{T}W_{M}=4f_{D}B/_{T}B (7)

the same as for _{D}M_{M}/_{T}M_{M}.

In turn, the voltage is governed by the induced back-voltage in sleeve length fL, per leaf, i.e.

_{D}V₁=vᵣfLB (8)

where vᵣ is the tangential velocity of the current tube wall, i.e. with ν the rotation rate in Hertz and ωᵣₚₘ the rotation rate in rpm:

vᵣ=πDν=πDωᵣₚₘ/60 (9)

whence

_{D}V₁=(π/60)fDLBωᵣₚₘ. (10)

Hence if the current flows consecutively through two turns each in all N_{DL}=πD/w leaves, the machine voltage will be

_{D}V_{M}=2V₁N_{DL}=(π²/30)fD²LBωᵣₚₘ/w=0.246D²LBωᵣₚₘ/w. (11)

The corresponding value for MP-T machines is

_{T}V_{M}=(π²/120)N_{T}BD²Lωᵣₚₘ/(KLₘₒ) (12)

for

_{D}V_{M}/_{T}V_{M}=4fKLₘₒ/N_{T}w. (13)

Again, the MP-D II b machine has an expected voltage advantage since N_{T} can rarely if ever exceed 6 and KLₘₒ, the zone width of MP-T machines, cannot be made as small as w,—in fact is liable to have a lower limit of about 3 mm while w may be made as small as 1 mm, as already indicated. Additionally, the manufacture of MP-D II b current tubes, if constructed as indicated including FIG. 16 B, is expected to be much simpler than of current tubes in MP-T machines, especially if N_{T} is made to be larger than unity.

The percentage ohmic heat loss, [symbol] , is found from the ratio of the ohmic voltage loss, _{D}V₁=i_{D}R_{1Ω} per turn to _{D}V₁, the induced voltage per turn in accordance with eq. 8. As already derived above, in the optimized design in which ΔL=4L_{b} and w*=w/2, the ohmic resistance per turn is 1.43 times larger than it would be for unobstructed conduction through cross section wT over the length of the current tube, i.e.

_{D}R_{1Ω}=1.43ρL/wKTₒ. (14)

Hence, with j=i/wKTₒ and for Case 3A with f=0.75,

[symbol]

=i_{D}R_{1Ω}/_{D}V₁=1.43×60ρj/(πfDBωᵣₚₘ)=36.4ρj/(DBωᵣₚₘ). (15)

Or numerically, with ρ=2×10⁻⁸ Ωm and f=0.75

[symbol]

=7.28×10⁻⁷j/(DBωᵣₚₘ). (16)

The equivalent expression for MP-T machines is

[symbol]

=60ρj/(πBDωᵣₚₘ) (17)

for

[symbol]

/ [symbol] =1.43/f=1.90. (18)

Thus the ohmic loss of MP-D II b machines is about double that of MP-T machines.

### Power Density, Weights and Materials Costs of MP-D II b Machines

Also of great interest is the weight of MP-D machines and the resulting power density as well as the materials cost. Specifically, for the present case of the MP-D II b machine, the amount of permanent magnet material in an MP-D II machine is, with f=0.75, d=8000 kg/m³ the approximate weight density or magnet material, and Hₘₒ=0.0125 m for Case 3A

_{D}mₘ=4πdfLDHₘ=4πdfLDKHₘₒ≅942KDL. (19)

This compares to

_{T}mₘ≅628KDL (20)

that was previously derived for MP-T machines. It follows that the torque/magnet mass ratio is

(_{D}M_{M}/_{D}mₘ)≅3.63×10⁻⁵Dj (21)

for MP-D machines and is

(_{T}M_{M}/_{T}mₘ)≅1.75×10⁻⁵Dj (22)

for MP-T machines, again an advantage of about the factor of two for MP-D machines.

Approximately, d=8000 kg/m³ is also the weight density of conductor material, i.e. typically copper, of flux return material and other structural materials such as axle 10, albeit, some components could be made of plastics. Further, in order to account for materials other than in the current and magnet tubes, a factor of 1.3 is introduced. With these assumptions, the weight of the current and magnet tubes except for the permanent magnet material will be, roughly,

_{D}m_{base}≈10πdDLDKHₘₒ≅3.3_{D}mₘ≅3100KDL (23)

and the total machine weight will be approximately

_{D}m_{M}˜1.3(mₘ+m_{base})≅5.5mₘ≅5200KDL (24)

compared to

_{T}m_{M}≅3200KDL (25)

for MP-T machines.

The power to weight density is found from eqs. 4, 6, 19 and 24 with Tₒ=2Hₘₒ for Case 4 and the other already assigned values (i.e. d=8000 kg/m³ and _{D}B=0.58 tesla) as

_{D}W_{M}/_{D}m_{M}=(π/60)D_{D}Bωᵣₚₘj/(5.5d)≅7.0×10⁻⁷Djωᵣₚₘ[watt/kg] (26)

while for MP-T machines one finds

_{T}W_{M}/_{T}m_{M}=3.54×10⁻⁷Djωᵣₚₘ[watt/kg]. (27)

Not surprisingly, this is much the same advantage by a factor close to two for MP-D machines that was already found for the torque per weight of permanent magnet material in eqs. 21 and 22.

Regarding materials, the approximate cost of the magnet material, Cₘ, is $40/kg, for

_{D}Cₘ≅$40mₘ≅$37,000KDL[mks] (28)

and the estimated approximate materials cost of the whole machine, C_{M}, at ˜$10/kg for materials other than permanent magnets, is

_{D}C_{M}≅$10×m_{M}+$40×mₘ≅$95×_{D}mₘ≅$90,000KDL[mks] (29)

compared to

_{T}C_{M}≅$96,000KDL[mks] (30)

that was previously derived for MP-T machines.

Concerning external machine dimensions, the flux return material about magnet tubes 5_{T} and 6_{T} has all of the required strength for the task but may need environmental protection, e.g. against corrosion or barnacles and other. This may be provided by means of some industrial coating, for example, that does not affect external dimensions. With reference to the diameter D of the mid-line (or better mid-surface) of the current tube, the outer machine diameter, D_{M}, will then be, with Hₘ=K Hₘₒ K 0.0125 m

D_{M}=D+12Hₘ=D+K×0.15 [m]. (31)

The machine length L_{M} will exceed the current tube length L, by the axial length of current tube end-piece 206_{E} and piece 180 that rigidly interconnects magnet tubes 5_{T} and 6_{T}, for an estimated total of, say, 4Hₘ=K×5.0 cm, i.e.

L_{M}=L+K×0.05 [m]. (32)

With these values, the machine volume becomes

[symbol]

=(π/4)(D+K×0.075)²(L+K×0.05)[m³]. (33)

### MP-D I b Machines

Given the same bypassing flux returns over segments of length ΔL=4L_{b} that are interleaved with current conducting channels of length 4L_{b} and width w*=w/2, the induced voltage per turn is the same in MP-D I b as in the above-discussed MP-D II b machines. However, there will now be only one voltage- and torque-producing turn per leaf as the current turns back in current return 171. Thus, while the contribution to torque and voltage per turn remain the same, the machine torque, _{D}M_{W}, and machine voltage, _{D}V_{M}, are halved, i.e. a factor of ½ is introduced in eq. 3, and factor 0.246 in eq. 11 is halved to 0.123. Meanwhile the loss is increased, namely to increase the factor of 36.4 at the right side of eq. 15 to 61.9. Further, the weight of magnet material is halved, i.e. in eq. 19 the factor 942 is reduced to 471, and the mass of the whole machine in eq. 24 is decreased from 5200 KDL to ˜3700 KDL.

Based on these results it is concluded that, for technological applications, MP-D I b machines, can be useful, especially at smaller sizes and not too low speeds. Herein the MP-D I b advantages of rather simple construction and of comprising only one magnet tube and only one moving interface, will be very valuable. Hence MP-D I b construction may be favored when ohmic loss is not a significant factor and/or when small size and simplicity of construction are important considerations.

Table II presents forecast MP-D I b and MP-D II b parameters in the style of Table I.

TABLE I
Forecast Performance of MP-D I t and II t Machines Compared to MP-T Machines

| MP-D I t and MP-D II t | | MP-T (Only Case 1A considered, |
|---|---|---|
| (For Cases 1A and 3A; Case 3A is best) | Comparison | which is best for MP-T) |
| _{D}A_{Z} = wKTₒ | _{D}A_{Z}/_{T}A_{Z} = wN_{T}/KLₘₒ | _{T}A_{Z} = K²LₘₒTₒ/N_{T} |
| | (may be as small as ~0.3) | |
| vᵣ = πDv = (π/60)Dωᵣₚₘ | same | vᵣ = πDv = (π/60)Dωᵣₚₘ |
| _{D}V₁ = fvᵣBL = f(π/60)BDLωᵣₚₘ | _{D}V₁/_{T}V₁ = f(_{D}B/_{T}B) | _{T}V₁ = vᵣ BL = (π/60)BDLωᵣₚₘ |
| 1A: f = ½, _{D}B = 0.56 t; fB = 0.27 t | 1A: f(_{D}B/_{T}B) = ½ | _{T}B = 0.56 tesla |
| 3A: f = 0.82, B = 0.58 t, fB = 0.47 | 3A: f(_{D}B/_{T}B) = 0.85 | |
| _{D}V_{M} = N_{DL} _{D}V₁/N_{U} = f(π²/60)BD²Lωᵣₚₘ/N_{U}w | _{D}V_{M}/_{T}V_{M} = f(_{D}B/_{T}B)K2Lₘₒ/w | _{T}V_{M}/N_{U} = N_{T}N_{Z} _{T}V₁ = |
| 1A: f = ½, B = 0.56; fB = 0.28 t | 1A: = KLₘₒ/w | (π²/120) N_{T}BD²Lωᵣₚₘ/(KLₘₒN_{U}) |
| 3A: f = 0.82, B = 0.58 t, fB = 0.48 t | 3A: = 1.71 KLₘₒ/w | ½ B = 0.28 t |
| _{D}i = j _{D}A_{Z} = j wKTₒ | at same j: _{D}i/_{T}i = w N_{T}/KLₘₒ | _{T}i = j _{T}A_{Z} = j K²Lₘₒ Tₒ/N_{T} |
| i_{M} = N_{U}i = N_{U} _{D}A_{Z}j | at same j and N_{U}: | i_{M} = N_{U}i = N_{U} _{T}A_{Z}j |
| | _{D}i_{M}/_{T}i_{M} = w N_{T}/KLₘₒ | |
| _{D}R₁~X ρL/_{D}A_{Z} = XρL/wKTₒ | _{D}R₁/_{T}R₁ = XKLₘₒ/wN_{T} | _{T}R₁ = ρL/_{T}A_{Z} = ρN_{T}L/(K²LₘₒTₒ) |
| 1A: X = 5.0 | 1A: 5.0KLₘₒ/wN_{T} | |
| 3A: X = 2.3 | 3A: X = 2.3 KLₘₒ/wN_{T} | |
| _{D}V_{1Ω}~_{D}i _{D}R₁ = XρLj | _{D}V_{1Ω}/_{T}V_{Ω} = X | _{T}V_{Ω} = _{T}i _{T}R₁ = ρLj |
| 1A: X = 5.0; | 1A: = 5.0; | |
| 3A: X = 2.3 | 3A: = 2.3 | |
| _{D}£ = 60Xρj/πfBDωᵣₚₘ | _{D}£/_{T}£ = X _{T}B/f_{D}B | _{T}£ = _{T}V_{Ω}/_{T}V₁ = 60ρj/(πBDωᵣₚₘ) |
| 1A: X − 5, fB = 0.29 t; X/fB = 17.9 [t⁻¹] | 1A: X_{T}B/f_{D}B = 10.0; | B = 0.56 t |
| 3A: X = 2.3, fB = 0.48 t; X/fB = 4.8 [t⁻¹] | 1B: X_{T}B/f_{D}B = 2.7 | |
| _{D}M_{M} = fN_{DT}(D/2)_{D}i LB = | _{D}M_{M}/_{T}M_{M} = 2f_{D}B/_{T}B | _{T}M_{M} = N_{T}N_{Z} (D/2)_{T}i LB = |
| f(π/2)KD²LTₒBj | 1A: 1.0 | (π/4)KD²LTₒBj |
| 1A: fB = 0.28 t | 1B: 1.70 | B = 0.56 t |
| 3A: fB = 0.48 | | |
| _{D}W_{M} = 2πv _{D}M_{M} = | _{D}W_{M}/_{T}W_{M} = 2f_{D}B/_{T}B | _{T}W_{M} = 2πv _{T}M_{M} = |
| f(π²/60)KD²LTₒBj ωᵣₚₘ | 1A: _{D}W_{M}/_{T}W_{M} = 1 | (π²/120)KD²LTₒBj ωᵣₚₘ |
| 1A: fB = 0.29 t | 1B: _{D}W_{M}/_{T}W_{M} = 1.71 | B = 0.56 t |
| 3A: fB = 0.48 | | |
| _{D}mₘ = d2πfDLKHₘₒ | _{D}mₘ/_{T}mₘ = f | _{T}mₘ = d2πDLKHₘₒ |
| 1A: f = ½, f = 0.82 | 1A: f = ½, f = 0.82 | |
| _{D}m_{M} ≅ 1.3dπDL(2KHₘₒ + 2KL_{bo} + 2KTₒ) = | _{D}m_{M}/_{T}m_{M} ≅ 10.4f/3.9 | _{T}m_{M} ≅ 2.6dπDL(KHₘₒ + |
| 1.3 _{D}mₘ[2 + (2L_{bo} + 2Tₒ)/Hₘₒ] | 1A: _{D}m_{M}/_{T}m_{M} ≅ 1.3 | KL_{bo} + KT₀/2) = |
| 1A and 3A: _{D}m_{M} ≅ 10.4 _{D}mₘ | 1B: _{D}m_{M}/_{T}m_{M} ≅ 1.6 | 1.3_{T}mₘ [1 + (L_{bo} + Tₒ/2)/Hₘₒ] ≅ 3.9_{T}mₘ |
| _{D}M_{M}/_{D}mₘ = DTₒBj/4dHₘₒ | (_{D}M_{M}/_{D}mₘ)/(_{T}M_{M}/_{T}mₘ) = 2 _{D}B/_{T}B | _{T}M_{M}/_{T}mₘ = DTₒBj/8dHₘₒ = DBj/4d |
| (independent of K!) | 1A: 2 | (independent of K!) |
| 1A and 3A: _{D}M_{M}/_{D}mₘ = DBj/2d; | 3A: 2(0.58/0.56) = 2.1 | |

TABLE II
Forecast Performance of MP-D I b, MP-D II b and MP-T Machine Parameters

| MP-D I b (Case 3A, B = 0.58 tesla) | MP-D II b (Case 3A, B = 0.58 tesl) | MP-T (Case 1A, B = 0.56 tesla) |
|---|---|---|
| f = 0.75, Hₘₒ = 1.25 cm, Tₒ = 2.5 cm | f = 0.75, Hₘₒ = 1.25 cm, Tₒ = 2.5 cm | Hₘₒ = 1.25 cm, Tₒ = 2.5 cm |
| _{D}A_{Z} = wKTₒ | _{D}A_{Z} = wKTₒ | _{T}A_{Z} = K²LₘₒTₒ/N_{T} |
| vᵣ = πDv = (π/60)Dωᵣₚₘ | vᵣ = πDv = (π/60)Dωᵣₚₘ | vᵣ = πDv = (π/60)Dωᵣₚₘ |
| _{D}V₁ = fvᵣBL = f(π/60)BDLωᵣₚₘ | _{D}V₁ = f vᵣBL = f(π/60)BDLωᵣₚₘ | _{T}V₁ = vᵣBL = (π/60)BDLωᵣₚₘ |
| (f = 0.75) | (f = 0.75) | |
| _{D}V_{M}= f(π²/60)BD²Lωᵣₚₘ/N_{U}w = | _{D}V_{M} = f(π²/30)BD²Lωᵣₚₘ/N_{U}w = | _{T}V_{M}/N_{U} = N_{T}N_{Z} _{T}V₁ = |
| 0.123 BD²Lωᵣₚₘ/N_{U}w | 0.246 BD²Lωᵣₚₘ/N_{U}w | (π²/120) N_{T}BD²Lωᵣₚₘ/(KLₘₒN_{U}) |
| _{D}i = j _{D}A_{Z} = j wKTₒ | _{D}i = j _{D}A_{Z} = j wKTₒ | _{T}i = j _{T}A_{Z} = j K²Lₘₒ Tₒ/N_{T} |
| i_{M} = N_{U}i = N_{U} _{D}A_{Z}j | i_{M} = N_{U}i = N_{U} _{D}A_{Z}j | i_{M} = N_{U}i = N_{U} _{T}A_{Z} j |
| _{D}R₁ = 2.43ρL/_{D}A_{Z} = 2.43ρL/wKTₒ | _{D}R₁ = 2.86ρL/_{D}A_{Z} = 2.86ρL/wKTₒ | _{T}R₁ = ρL/_{T}A_{Z} = ρN_{T}L/(K²LₘₒTₒ) |
| _{D}R_{M} = N_{DL} _{D}R₁ = 7.63ρDL/w²KTₒ | _{D}R_{M} = N_{DL} _{D}R₁ = 8.98ρDL/w²KTₒ | _{T}R_{M} = N_{Z}N_{TT}R₁ = πDρN_{T}² L/(K³Lₘₒ² [symbol] |
| _{D}V_{1Ω} = _{D}i _{D}R₁ = 2.43ρLj | _{D}V_{1Ω} = _{D}i _{D}R₁ = 2.86ρLj | _{T}V_{1Ω} = _{T}i _{T}R₁ = ρLj |
| _{D}£ = 2.43 × 60ρLj/fπBDLωᵣₚₘ = | _{D}£ = 2.86 × 60ρLj/fπBDLωᵣₚₘ = | _{T}£ = 60ρj/(πBDωᵣₚₘ) = |
| 61.9ρj/(BDωᵣₚₘ) | 36.4ρj/(BDωᵣₚₘ) | 19.1 ρj/(BDωᵣₚₘ) |
| _{D}M_{M} = fN_{DT}(D/2) i LB = | _{D}M_{M} = fπKD² LTₒ Bj = | _{T}M_{M} = N_{T}N_{Z} (D/2) i LB = |
| f(π/2)KD²LTₒBj = 0.0171 KD²Lj | 2.36 KD²LTₒBj = 0.0342 KD²Lj | (π/4)KD²LTₒBj = 0.0110KD²Lj |
| _{D}W_{M} = f(π²/60)KD²LTₒBj ωᵣₚₘ = | _{D}W_{M} = f(π²/30) KD² LTₒ Bj ωᵣₚₘ = | _{T}W_{M} = (π²/120)KD²LTₒBj ωᵣₚₘ = |
| 1.79 × 10⁻³KD²Ljωᵣₚₘ | 3.76 × 10⁻³KD²Ljωᵣₚₘ | 1.15 × 10⁻³KD²Ljωᵣₚₘ |
| _{D}m_{M} = d2πfDLKHₘₒ ≅ 471 KDL | _{D}mₘ = d4πfDLKHₘₒ ≅ 942 KDL | _{T}mₘ = d2πDLKHₘₒ ≅ 628 KDL |
| d = 8000 kg/m³ | d = 8000 kg/m³ | d = 8000 kg/m³ |
| _{D}m_{M} ≅ 1.3dπDL(2KHₘₒ + 2KL_{bo} + 2KTₒ) ≅ | _{D}m_{M} ≅ 5.5 _{D}mₘ ≅ 5200 KDL | _{T}m_{M} ≅ 2.6dπDL(KHₘₒ + KL_{bo} + KTₒ/ [symbol] |
| 6.9 _{D}mₘ ≅ 3270 KDL | | 1.3_{T}mₘ[1 + (L_{bo} + Tₒ/2)/Hₘₒ] ≅ 3.9_{T}mₘ ≅ |
| | | 2450 KDL |
| _{D}W_{M}/_{D}mₘ = 3.8 × 10⁻⁶Djωᵣₚₘ | _{D}W_{M}/_{D}mₘ = 3.8 × 10⁻⁶Djωᵣₚₘ | _{T}W_{M}/_{T}mₘ = 1.83 × 10⁻⁶Djωᵣₚₘ |
| _{D}M_{M}/_{D}mₘ = 0.0025 DTₒ Bj ≅ 3.62 × 10⁻⁵Dj | _{D}M_{M}/_{D}mₘ = 0.0025DTₒ Bj/d ≅ | _{T}M_{M}/_{T}mₘ = DTₒBj/8dHₘₒ ≅ 1.75 × 10⁻⁵I |
| (Depends on K only through D and j) | 3.62 × 10⁻⁵Dj | |
| _{D}W_{M}/_{D}m_{M} ≅ 5.5 × 10⁻⁷Dj ωᵣₚₘ | _{D}W_{M}/_{D}m_{M} ≅ 6.9 × 10⁻⁷Dj ωᵣₚₘ | _{T}W_{M}/_{T}m_{M} ≅ 4.69 × 10⁻⁷Dj ωᵣₚₘ |
| Cₘ (permanent magnet cost) ≅ $40 × _{D}mₘ = | Cₘ ≅ $40 × _{D}mₘ = $37,700 KDL | Cₘ ≅ $40 × _{T}mₘ = $25,100 KDL |
| $18,800 KDL (D and L in [m]) | | |
| C_{M}(Machine Materials Cost) ≅ 2.5 Cₘ ≅ | C_{M} ≅ 2.1Cₘ ≅ $79,900 KDL [mks] | C_{M} ≅ 1.72 Cₘ ≅ $43,340 KDL[mks] |
| $46,500 KDL [mks] | | |
| C_{M}/W_{M} ≅ $2.6 × 10⁷/Djωᵣₚₘ [mks] | C_{M}/W_{M} ≅ $2.13 × 10⁷/Djωᵣₚₘ [mks] | C_{M}/W_{M} ≅ $3.77 × 10⁷/Djωᵣₚₘ [mks] |

[symbol]

indicates data missing or illegible when filed

### NUMERICAL EXAMPLES

### Example a

### An MP-D I b Motor of 100 hp Power and 200 rpm Speed, M_{M}=3580 Nm

At W_{M}=7.5×10⁴ watt and ωᵣₚₘ=200 rev/min, the torque is M_{M}=60×7.5×10⁴/2π200=3580Nm. According to eq. 3 modified by factor ½ it is then, for Case 3A with f=0.75, Tₒ=2.5 cm and _{D}B=0.58 tesla, using mks units throughout,

_{D}M_{M}=1/2fπD²KTₒL_{D}Bj=0.0171KD²Lj[mks]=3580[Nm]. (34a)

The first decision will be the choice of K, which will be made as small as possible in order to lighten the machine and save cost of permanent magnet material. It is a judgment call to decide on the practical lower limit of K. Provisionally we may choose K=0.08 to let the magnets be Hₘ=K 1.25 cm=1 mm thick and the sleeves be L_{m/}=12 Hₘ=1.2 cm wide in axial direction. These appear to be reasonable numbers that permit magnets to be handled without undue difficulty, and in mass production by means of automatic machinery.

With the choice of K=0.08 we obtain

D²Lj=3580/(0.0171K)=2.62×10⁶. (35a)

The next choice then is of the current density j. One will wish to make this as large as possible in order to obtain a small value of D² L and thus low magnet and machine weight, but one is constrained by the fact that the loss, [symbol] , is proportional to j in accordance with eq. 15 as modified for an MP-D I b motor, namely

[symbol]

=61.9ρj/(DBωᵣₚₘ). (36)

Knowing that the motor may be readily cooled while its cost steeply decreases with rising L, we shall choose [symbol] =5% to obtain, with ρ≅2×10⁻⁸ Ωm,

61.9ρj/(DBωᵣₚₘ)=1.07×10⁻⁸j/D=0.05 (37a 1)

or

j=4.67×10⁶D. (37a 2)

For the reasonable choice of D=1.0m (in order not to lower j too much nor end up with an unreasonably large motor) we find

j=4.67×10⁶[A/m²]=467A/cm². (37a 3)

Returning to eq. 35, we then find, with D=1.0 m,

L=0.56 m (38a)

In accordance with eq. 19 as modified for MP-D I b machines, a motor with these dimensions will comprise

mₘ≅471KDL=21.1 kg (42a)

magnet mass costing Cₘ≅$850 and, following modified equation 24, will have mass m_{M}=3270 KDL=147 kg=323 lbs, for a weight power density of 3.23 lbs/hp or 0.51 kW/kg.

Still to be chosen is the leaf width, w, on which the motor voltage depends. Following eq. 11, with halved voltage on account of considering an MP-D I b motor instead of an MP-D II b machine, the motor voltage will be, neglecting a correction for the loss L,

V_{M}=0.123D²LBωᵣₚₘ/w=7.6/w[V]. (39a)

Since generally it is advantageous to choose voltage and current at about the same level, in this case w=2.5 cm would seem a good choice to yield V_{M}=7.6/0.025 [V]=304 V, together with a current of i_{M}=247 A.

Since with K=0.08 the torque-producing current path is only T=KTₒ=2 mm thick, cooling cannot be done by means of cooling channels embedded in the current-conducting sections 2(n). Therefore either a cooling jacket as in FIGS. 1 and 2 may be used, or a cooling channel embedded in flux return 171.

In summary, an MP-D II b type motor of W_{M=}75 kW power and 200 rpm rotation speed could be built with L_{m/}=1=1.2 cm wide sleeves separated by 4 mm gaps in an L=56 cm long current tube (i.e. incorporating 35 sleeves), and powered with ˜250 A/˜300V electricity. The motor would have a diameter of D_{M}˜1.0 m, and weigh about 323 lbs. The magnets in it would be 1 mm thick and would cost ˜$850. Other materials in the motor would bring the total materials cost to C_{M}˜2.5 Cₘ=$2,130 The motor would be about 95% efficient and would be water cooled. The construction would be relatively simple and while good accuracy is needed to assure smooth rotation of the inner magnet tube relative to the stationary current tube that surrounds it, no particular accuracy would be needed otherwise. Specifically, the leaves would be 2.5 cm wide and will be permanently connected to each other, and the current would flow through them sequentially. Note that this is but one of a literally infinite variety of parameter combinations with different currents, voltages, diameters and length to diameter aspect ratios.

### Example b

### MP-D I b Wheel Chair Motor (M_{M}=40 Nm, 6 V/420 W)

### No Reduction Gear

We begin with the same method as above and start with the equivalent of eq. 34(a), i.e.

_{D}M_{M}=½f πD²KTₒL_{D}Bj=0.0171KD²Lj[mks]=40[Nm] (34b 1)

and making the same choice for K, i.e. K=0.08 find

D²Lj=40/(0.0171K)=2.92×10⁴[mks]. (35b)

Next, we choose the largest reasonably practical diameter of D=18 cm, and are content with an ohmic loss of [symbol] =50% at the top speed of ωᵣₚₘ≅100 rpm, for the reason that torque is the principal desired output of wheelchair motors while efficiency is of secondary interest. With these choices we find from eq. 36

[symbol]

=61.9ρj/(DBωᵣₚₘ)=0.50=1.19×10⁻⁷j (37b 1)

for

j=4.22×10⁶A/m²=422A/cm². (37b 2)

Inserting this into eq. 35 b, together with K=0.08 and D=0.18 m renders L=0.214 m.

Following eq. 39(a) the leaf thickness, w, is determined so as to yield machine voltage V_{M}=12V at ωᵣₚₘ,=100 rpm, i.e.

V_{M}=0.123D²LBωᵣₚₘ/w=6 [V]=0.0495/w for w=0.82 cm. (39b 1)

With a current path area of A_{Z}=wKTₒ=0.165 cm², at j=422 A/cm² the machine current is i_{M}=70 [A] which supplies the torque

M_{M}=(D/2)N_{DL}BfLi=½πfD²LBi/w=40[Nm] (40)

and the top machine power will be W_{M}=V_{M} i_{M}=420 watt.
The required amount of permanent magnet material is

mₘ=471KDL=1.45 kg at a cost of Cₘ≅$58 (41b)

and the motor will weigh

m_{M}≅3270KDL≅6.9mₘ=10.0 kg≅22 lbs. (42)

Same Specifications for Wheel Chair Motor but with Reduction Gear

Weight and cost of the motor may be reduced by the use of a reduction gear as follows:

Using, once again, K=0.08 and the same current density of j=4.22×10⁶ A/m² but choosing the much smaller current path diameter of D=0.078 m, equation 35b yields

D²Lj=2.92×10⁴[mks]=2.57×10⁴L[mks] for L=1.17 [m] (43 1)

i.e. an absurdly long length for a wheel chair. As a remedy, a reduction gear of ratio N_{R} will, at same output speed, ωᵣₚₘ, permit the motor to run at speed N_{R}ωᵣₚₘ and, neglecting friction losses, will increase the output torque by the same factor N_{R} relative to the motor torque.

For this example we assume a reduction gear ratio of N_{R}=9. The motor input speed will then be N_{R}ωᵣₚₘ=900 rpm and the input motor torque will be M_{M}=40/N_{R}=4.44[Nm]. Thereby eq. 34 is transformed into

_{D}M_{M}*=½fπD²KTₒLDBj=0.0171KD²Lj[mks]=40/N_{R}=4.44[Nm]. (34b 2)

For the same K=0.08 and j=4.22×10⁶ A/m² as before, and with D=0.078 m, eq. (34b 2) requires

L=4.44/(0.0171KD²j)=0.129 m=12.9 cm. (44)

For those same values the loss at top speed becomes

[symbol]

=61.9ρj/(DBN_{R}ωᵣₚₘ)+ [symbol] _{RG}≅0.128+0.10≅23% (37b 3)

where [symbol] _{RG} is the reduction gear loss, assumed to be [symbol] _{RG}≈10%.

Again based on eq. 39a, the leaf thickness is chosen to yield machine voltage V_{M}=6 [V] but now at N_{R}ωᵣₚₘ,=900 rpm, as

V_{M}=0.123D²LBN_{R}ωᵣₚₘ/w=0.048/w=6[V] for w=0.80 cm (39b 2)

i.e. formally N_{DL}=πD/w=30.6 leaves but practically, say, N_{DL}=31 leaves, or perhaps 32 or even 33 leaves, of which one or two situated between the input and output cables to the battery may be left idle as insulating spaces between the terminals.

With the current path cross section A_{Z}=KTₒw=0.08×2.5×0.8 cm²=0.16 cm², at current density j=422 A/cm², the machine current will be i_{M}˜70 A,—the same as without reduction gears. At full speed, i.e. at V_{M}=6V, therefore, the motor power would be W_{M}=420 w.

On account of the reduction gear, the magnet material needed for this much smaller machine will be mₘ≅471 KDL=0.38 kg at a cost of ˜$15. And, again following modified eq. 24, the machine mass will be m_{M}≅3270 KDL=2.6 kg s≅5.8 lb, to which must be added the weight of the reduction gear.

In summary, MP-D I b machines can be made in small sizes, e.g. for direct drive wheel chair motors or in conjunction with reduction gears. Without reduction gear the forecast weight is about 22 lbs and with reduction gear, for the motor alone, the weight is only about one quarter of that, namely in the particular case considered, 5.8 lbs.

Specifically, the internal resistances of the machine proposed above are, following eq. 14 as adapted to MP-D I b machines

_{D}R_{M}=1.77×1.43πρDL/(w²KTₒ)=7.95×10⁻⁵LD/w²[mks] (45)

i.e. 0.0125Ω with reduction gear. Therefore, in slow motion at maximum 70 A current, the waste heating will only be ˜60 Watt.

### Example c

### A 6100 hp/120 rpm Ship Drive, W_{M}=4.6 MW, M_{M}=3.6 MNm

### MP-D I b Construction

Even though the MP-D II b design promises somewhat reduced weight as well as materials cost and at same current density considerably lowered loss, the very simple construction and application of MPD I b machines, the latter on account of only one sliding interface and a stationary instead of rotating outer casing, can outweigh those advantages. This next example will therefore also make use of a MP-D I b design, as follows.

Torque equation 34 for this particular case will be for the above specifications,

_{D}M_{M}=½f πD²KTₒL_{D}Bj=0.0171KD²Lj[mks]=3.6×10⁶[Nm] (34c 1)

i.e.

j=2.10×10⁸/KD²L. (34c 2)

Next, as in the previous cases, the current density has to be chosen with due regard to the ohmic loss, i.e. Eq. 37, but on account of the low rotation rate and in order to reduce weight and cost select as much as possible, we permit a 10% loss, i.e. with ωᵣₚₘ=120 rpm,

[symbol]

=61.9ρj/(DBωᵣₚₘ)=1.78×10⁻⁸j/D=0.10[mks] (37c 1)

to find

j=5.6×10⁶D[A/m²] (37c 2)

independent of K. Combining (34c 2) with (37c 2) yields, with eq. (41b),

2.10×10⁸/KD²L=5.6×10⁶D(46c 1)

or

KD³L=37.5=D²mₘ/471. (46c 2)

Thus, according to (46c 2) the mass of magnet material is

mₘ=1.77×10⁴/D² (46c 3)

i.e. for fixed torque and loss, mₘ is seemingly independent of K. However, indirectly the magnet mass mₘ does depend on K, namely via D that for any chosen K slowly changes with rotation speed and machine length. If K is picked simply for best manufacturing convenience, it will probably be chosen between 0.3 and 1. Further, strongly squat motors are desirable for low weight and cost but may be unfavorable on account of user's space requirements, for example if a motor shall be housed in a pod it should preferably be slender. The choice of D thus depends on circumstances. Assuming that choice of aspect ratio L/D is rather unconstrained, L=D/2 would seem reasonable. With L=D/2, eq. (46 2) yields

D=(75K)^{1/4} [m]=2.94/K^{1/4} m with L=D/2=1.47/K^{1/4} (47c)

i.e. only mildly dependent on K, except via its connection to _{D}M_{M} and j which, from eq. (37c 2) with eq. 47, is

j=5.6×10⁶D 8.23×10⁶/K^{1/4}. (37c 3)

Motor with K=1 (Hₘ 1.25 Cm) and Vₘ=2000V/2300 A

Values for both K and V_{M} are chosen next. If the choices are K=1 and V_{M}=2000 V with i_{M}=2,300 A, then from eq. (47): D=2.94 m and L=1.47. In this case, D=2.94 m and L=1.47 m. Further, from eq. 39 with eq. 47,

w=0.123D²LBωᵣₚₘ/V_{M}=0.0544 [m]=5.4 cm. (48c 1)

The resulting magnetic material mass becomes mₘ=471 KDL=2035 kg at a cost of $81,000 and the whole machine weight becomes according to eq. 42

m_{M}≅3270KDL≅6.9mₘ≅14,200 kg=31,000 lbs (42 c)

for materials cost C_{M}≅$46,500×KDL=$200,000 and weight power density of ˜5.1 lbs/hp.
Same Motor but with K=2 (Hₘ=2.5 cm) and V_{M}=2000V, i_{M}=2300 A

From eq. 47, with K=2, obtain D=(75/K)^{1/4} [m]=2.47 m and L=1.24 m, whence from (37c 2)

j=5.6×10⁶D=1.38×10⁷ A/cm² (37c 4)

and

w=0.123D²LBωᵣₚₘ/V_{M}=0.035 [m]=3.2 cm (48c 2)

for magnetic materials mass mₘ=471 KDL=2890 kg at a cost of ˜$115,000 and total machine mass m_{M}≅6.9mₘ=19,900 kg≅43,700 lbs and materials cost of C_{M}≅2.5 Cₘ=$288,000. The power density will be ˜7.2 lbs/hp.

Values with K=0.32 (Hₘ=4 mm) and V_{M}=2000V/2300 A

From eq. 47, with K=0.32, obtain D=(75/K)^{1/4} [m]=3.90 m and L=1.95 m, whence

j=5.6×10⁶D=1.53×10⁷/K^{1/4}=2.03×10⁷A/cm² (37c 4)

and

w=0.123D²LBωᵣₚₘ/V_{M}=0.127 [m]=12.7 cm (48c 1)

for magnetic materials mass mₘ=471 KDL=1146 kg at a cost of Cₘ≅$ 45,800 and total machine weight of m_{M}≅6.9mₘ≅7910 kg≅17,400 lbs, and materials cost for the motor of C_{M}≅20.5 Cₘ=$115,000. The power density will be m_{M}/w_{M}=2.85 lbs/hp.
Conclusions: In terms of power density and cost, there is a clear advantage in choosing small K values. However, according to eq. 46, the outer machine dimensions decrease in proportion with 1/K^{1/4} and the number of magnet pieces that need to be installed during manufacture rises as D², i.e. as 1/√ K. These facts argue against an unduly small K value. Further, with decreasing K values, the current density, j, increases as l/K^{1/4}, and in this example may be overly high on account of choosing the high loss value of [symbol] =10% at full torque. BUT, because the machines will be very easily cooled, this poses no cooling problem but the current may exceed mechanical stability. Since the torque as well as the loss are proportional to j, decreasing [symbol] increases the machine weight and lowers the power density proportionately. In any event, for small K values, when power densities are acceptably high, the machine dimensions appear to be uncomfortably large. These problems are reduced by means of an MP-D II b construction, as follows.

### Example d

### A 6100 Hp/120 rpm Ship Drive, W_{M}=4.6 MW, M_{M}=3.6 MNm

### MP-D II b Construction

The analysis for MP-D II b machines is closely the same as for MP-D I b machines above, except for the already indicated changes at the end of section “Approximate Flux Line Patterns . . . ” and as listed in Table II. Accordingly the machine torque is

_{D}M_{M}=fπD²KTₒL_{D}Bj=0.0342KD²Lj[mks]=3.6×10⁶[Nm] (34d 1)

i.e.

j=1.05×10⁸/KD²L. (34d 2)

Next, again permitting a 10% loss at ωᵣₚₘ=120 rpm,

[symbol]

=36.4ρj/(DBωᵣₚₘ)=1.05×10⁻⁸j/D=0.10[mks] (37d 1)

find

j=9.5×10⁶D[A/m²] (37d 2)

and from (34d 2) with (37d 2), i.e. from j=1.05×10⁸/KD²L=9.5×10⁶ D obtain

KD³L=11.1 (46d 1)

and with

mₘ=942KDL (41c)

KD³L=11.1=D²mₘ/942. (46d 2)

So that the mass of magnet material for this machine in MP-D II b construction is

mₘ=1.05×10⁴/D². (46d 3)

Again taking an aspect ratio of L/D=½, (46d 2) yields

D=(22.2/K)^{1/4} [m]=2.17/K^{1/4}m with L=D/2=1.09/K^{1/4} (47d 1)

while from eq. (37d 2) with eq. 47d it is

j=9.5×10⁶D=9.5×10⁶2.17/K^{1/4}=2.0×10⁷/K^{1/4} (37d 3)

Motor with K=1 (Hₘ=1.25 cm) and 2000V/2300 A

For K=1 and V_{M}=2000V/2300 A, find from (47d 1) for D and L

D=2.17/K^{1/4}m=2.17 m and L=D/2=1.09 m (47d 2)

and from eq. 39, with eq. 47,

V_{M}=0.246D²LBωᵣₚₘ/w=2000=88/w[V] (39d 1)

w=0.044 m=4.4 cm (48d 1)

for πD/w=155 leaves,—or again, as in the other cases above, perhaps one or a few more as voltage buffer between the terminals with their 2000 V potential difference.

With this construction the magnetic material mass becomes

mₘ=942 KDL=2,230 kg at a cost of Cₘ=$89,000 (42d 1)

while the whole machine weight becomes

m_{M}≅5.5.mₘ≅12,300 kg=27,000 lbs (42d 2)

for a weight power density of ˜4.4 lbs/hp, and total materials cost of

C_{M}≅2.1 Cₘ≅$37,700×KDL=$187,000. (42d 3).

Same Machine with K=0.32 (Hₘ=0.4 cm), 2000V, 2300 A, and [symbol] =10%

With K=0.32 and otherwise the same values eq. (47d) yields

D=2.171K^{1/4} m=2.88 m and L=D/2=1.44 m (47d 2)

while eq. 39 with eq. 47 yields

V_{M}=0.246D²LB ωᵣₚₘ/w=204/w [mks]=2000 [V] (39d 2)

w=0.102 m=10.2 cm (48d 2)

for πD/w=89 or 90 leaves. The magnetic material mass is then

mₘ=942KDL=1250 kg at a cost of Cₘ=$50,000 (42d 2)

and the machine weight

m_{M}≅5.5.mₘ≅6875 kg=15,100 lbs (42d 3)

for a weight power density of ˜2.5 lbs/hp, and total materials cost of

C_{M}≅2.1Cₘ≅$37,700×KDL=$50,000. (42d 3)

Same Machine with K=0.32 (Hₘ=0.4 cm) and V_{M}=2000V/2300 A but with [symbol] =5% at Top Speed

Reducing the permissible loss by the factor of two, reduces the permissible current density, j, by the same factor, i.e. to

j=4.8×10⁶D[A/m²] (37d 4)

and from (34d 2) with (37d 4), i.e. from j=1.05×10⁸/KD²L=4.8×10⁶ D obtain

KD³L=21.9 (46d 4)

i.e. with

mₘ=942KDL (41c)

KD³L=21.9=D²mₘ/942 (46d 5)

for

mₘ=2.06×10⁴/D². (46d 6)

With the same aspect ratio of L/D=1/2 as before, (46d 5) yields

D=(43.8/K)^{1/4} [m]=2.57/K^{1/4} m with L=D/2=1.29/K^{1/4} (47d 3)

while from eq. (37d 2) with eq. (47d 3) it is

j=4.8×10⁶D=4.8×10⁶×2.17/K^{1/4}=1.04×10⁷/K^{1/4}. (37d 5)

Next, with K=0.32, eq. (47d 3) yields

D=(43.8/K)^{1/4} m=3.42 m and L=D/2=1.71 m (47d 4)

while eq. 39 with eq. (47d 4) yields

V_{M}=0.246D²LBωᵣₚₘ/w=342/w [mks]=2000 [V] (39d 3)

for

w=0.17 m=17.1 cm (48d 2)

i.e. formally πD/w=62.8 leaves, and practically 63 or 64 leaves.

The magnetic material mass is then

mₘ=942KDL=1730 kg at a cost of Cₘ=$69,200 (42d 4)

and the machine weight

m_{M}≅5.5.mₘ≅9520 kg=20,900 lbs (42d 5)

for a weight power density of ˜3.43 lbs/hp, and total materials cost of

C_{M}≅2.1 Cₘ≅$37,700×KDL=$145,000.

### Example e

### MP-D I b Motor of W_{M}=300 kW/1100 rpm i.e. M_{M}=2600 MNm

### MP-D I b Construction

Torque equation 34 yields for this case (with f=0.75 and B=0.58 tesla as throughout)

_{D}M_{M}=1/2f D²KTₒL_{D}Bj=0.0171KD²Lj[mks]=2600[Nm] (34e 1)

for

j=1.52×10⁵/KD²L. (34e 2)

Next, again permitting a 10% loss but now at ωᵣₚₘ=1100 rpm, obtain with ρ=2×10⁻⁸ Ωm

[symbol]

=61.9ρj/(DBωᵣₚₘ)=1.94×10⁻⁹j/D=0.10[mks] (37e 1)

for

j=5.15×10⁷D[A/m²] (37e 2)

and from (34e 2) with (37e 2), i.e. from j=1.52×10⁵/KD²L=5.15×10⁷D obtain

KD³L=2.95×10⁻³ (46e 1)

and with

mₘ=471KDL (41e 1)

have

KD³ L=0.00295=D²mₘ/471 (46e 2)

so that the mass of magnet material for this machine in MP-D I b construction is

mₘ=1.39/D². (46e 3)

In this case an aspect ratio no smaller than D/L=1 is desired. With this, (46e 1) yields

D=L=(2.95×10⁻³/K)^{1/4} [m]=0.233/K^{1/4} m (47e 1)

From eq. (37e 2) and eq. (47e 1) we then find

j=5.15×10⁷D=5.15×10⁷×0.233/K^{1/4}=1.20×10⁷/K^{1/4}. (37e 3)

Motor with K=0.1 (Hₘ=0.125 cm) and V_{M}=800V/375 A

For K=0.1, V_{M}=800V and i_{M}=375 A, find from (47e 1)

D=L=0.233/K^{1/4} m=0.562 m (47e 2)

and from eq. 39, with eq. (47e 2)

V_{M}=0.123D²LBωᵣₚₘ/w=14.0/w[mks]=800 [V] (39e 1)

for

w=0.0174 m=1.74 cm (48e 1)

for, formally, πD/w=101.5 leaves, or practically speaking probably 102 or 103 leaves.

With this construction the magnetic material mass becomes

mₘ=471KDL=14.9 kg at a cost of Cₘ=$596 (42e 1)

while the whole machine weight becomes

m_{M}=7.8.mₘ≅116 kg=255 lbs (42e 2)

for a weight power density of ˜0.64.1 lbs/hp, and total materials cost of

C_{M}≅2.7 Cₘ≅$51,000×KDL=$1610. (42e 3)

Motor with [symbol] =5%, K=0.2 (Hₘ=0.25 cm), V_{M}=800V and i_{M}=375 A

For a loss of 5% at top speed with K=0.2 and V_{M}=800V/375 A, find from (37e 1)

j=2.58×10⁷D (37e 4)

and with (34e 2) as well as D=L

j=2.58×10⁷D=1.52×10⁵/KD²L [symbol] j=2.58×10⁷D=1.52×10⁵/KD³ (34e 3)

i.e.

KD⁴L=5.89×10⁻⁵ (47e-3)

for

D=L=0.277/K^{1/4} m=0.414 m (47e 4)

and from eq. 39, with eq. (47e 4)

V_{M}=0.123D²LBωᵣₚₘ/w=5.57/w [mks]=800 [V] (39e 2)

w=0.0069 m=0.69 cm (48e 2)

for, formally, πD/w=188.5 leaves.

The current density is then

j=i_{M}/(2KHₘₒw)=375/(0.4×0.0125×0.0069)[mks]=1.09×10⁷A/m² (37e 5)

With this construction the magnetic material mass becomes

mₘ=471KDL=16.1 kg=35.4 lbs at a cost of Cₘ=$646 (42e 4)

while the whole machine weight becomes

m_{M}≅7.8.mₘ≅126 kg=276 lbs (42e 5)

for a weight power density of ˜0.69 lbs/hp, and total materials cost of

C_{M}=2.7Cₘ≅$51,000×KDL=$1750. (42e 6)

### Example f

### MP-D I b Motor of W_{M}=300 kW/1100 rpm i.e. M_{M}=2600 MNm

MP-D II b Construction (with L=5%, K=0.2 (Hₘ 0.25 cm), V_{M}=800V and i_{M}=375 A)

In parallel with example d, with MP-D II b machine construction the machine torque for this example is

_{D}M_{M}=fπD² KTₒL_{D}Bj=0.0342KD²L j[mks]=2600[Nm] (34f 1)

i.e.

j=7.60×10⁴/KD²L. (34f 2)

Permitting a 5% loss at ωᵣₚₘ=1100 rpm yields

[symbol]

=36.4ρj/(DBωᵣₚₘ)=1.14×10⁻⁹j/D=0.05[mks] (37f 1)

for

j=4.38×10⁷D[A/m²]. (37f 2)

Further, from (34f 2) with (37f 2), i.e. from j=7.60×10⁴/KD²L=4.38×10⁷D obtain

KD³L=1.76×10⁻³ (46f 1)

and with

mₘ=942KDL (41f)

KD³L=1.76×10⁻³=D²mₘ/942. (46f 2)

Thus the mass of magnet material for this machine in MP-D II b construction is

mₘ=1.64/D² (46f 3)

Taking L=D as in examples “e” above, yields from eq. (46f 2)

D=L=(1.76×10⁻³/K)^{1/4} [m]=0.205/K^{1/4} [m] (47f 1)

while from eq. (37f 2) with eq. (47f 1) it is

j=4.38×10⁷D=4.38×10⁷×0.205/K^{1/4}=8.97×10⁶/K^{1/4}. (37f 3)

For K=0.2 and V_{M}=800V, find from (47f 1)

D=L=0.205/K^{1/4} [m]=0.306 m (47f 2)

and from eq. 39, with eq. 47,

V_{M}=0.246D²LBωᵣₚₘ/w=4.50/w=800 [V] (39f 1)

and

w=0.0056 m=0.56 cm (48f 1)

for πD/w=172 leaves,—or, say, 173 or 174 with one or a coupe extra leaves.

With these values the current density becomes, with eq. (37f 3)

j=1.34×10⁷A/m²=i_{M}/2KHₘₒw (37f 4)

and the mass of magnetic material in the machine becomes

mₘ=942KDL≅17.6 kg≅38.8 lbs at a cost of Cₘ=$704. (42f 1)

The whole machine weight is found as

m_{M}≅5.5.mₘ≅96.8 kg=213 lbs (42f 2)

for a weight power density of ˜0.53 lbs/hp, and total materials cost of

C_{M}≅2.1 Cₘ≅$79,900KDL=$1,490. (42d 3)

TABLE III
Numerical Data

| | MB-D | W_{M} | | | | D | | | j | w | N_{DL} = | mₘ | m_{M} | | | m_{M}/W_{M} |
|---|---|---|---|---|---|---|---|---|---|---|---|---|---|---|---|---|
| Case | I or II b | [kW] | ωᵣₚₘ | [symbol] % | K | [m] | L [m] | V_{M} | [A/cm²] | [cm] | πD/w | [kg] | [kg] | Cₘ [$] | C_{M} [$] | [lbs/hp] |
| a¹ | Ib | 75 | 200 | 5 | 0.08 | 1.0 | 0.56 | 304 | 467 | 2.5 | 126 | 21.1 | 147 | 850 | 2,130 | 3.25 |
| b² | Ib | 0.42 | 100 | 50 | 0.08 | 0.18 | 0.214 | 6 | 422 | 0.82 | 69 | 1.45 | 10.0 | 58 | 145 | >~50 |
| | no gear | 40 Nm | | | | | | | | | | | | | | |
| b² | w.gear | ″ | 100 | 23 | 0.08 | 0.078 | 0.129 | 6 | 422 | 0.80 | 31 | 0.38 | 2.6 + g | 15 | 38 + g | |
| c³ | I b | 4600 | 120 | 10 | 1.0 | 2.94 | 1.47 | 2,000 | 1,650 | 5.4 | 172 | 2035 | 14,200 | 81,000 | 200,000 | 5.1 |
| c³ | ″ | ″ | ″ | ″ | 2.0 | 2.47 | 1.24 | ″ | 1,380 | 3.2 | 240 | 2890 | 19,900 | 115,000 | 288,000 | 7.2 |
| c³ | ″ | ″ | ″ | ″ | 0.32 | 3.90 | 1.95 | ″ | 2,030 | 12.7 | 97 | 1146 | 7910 | 45,800 | 115,000 | 2.9 |
| d³ | II b | ″ | ″ | ″ | 1.0 | 2.10 | 1.09 | ″ | 2,000 | 4.4 | 155 | 2230 | 12,300 | 89,000 | 187,000 | 4.4 |
| d³ | ″ | ″ | ″ | ″ | 0.32 | 2.88 | 1.44 | ″ | 2,740 | 10.2 | 89 | 1250 | 6875 | 50,000 | 105,000 | 2.5 |
| d³ | ″ | ″ | ″ | 5 | ″ | 3.42 | 1.71 | ″ | 1,650 | 17.1 | 64 | 1730 | 9520 | 69,200 | 145,000 | 3.43 |
| e⁴ | I b | 300 | 1100 | 10 | 0.1 | 0.562 | 0.562 | 800 | 2,100 | 1.74 | 102 | 14.9 | 103 | 596 | 1490 | 0.57 |
| e⁴ | ″ | ″ | ″ | 5 | 0.2 | 0.414 | 0.414 | ″ | 1,090 | 0.69 | 189 | 16.1 | 111 | 646 | 1620 | 0.61 |
| e⁴ | II b | ″ | ″ | 5 | 0.2 | 0.306 | 0.306 | ″ | 1,340 | 0.56 | 172 | 17.6 | 96.8 | 704 | 1490 | 0.53 |

Superscripts:
¹= SBIR Prototype;
²= Wheel Chair motor;
³= SBIR Full Size;
⁴= Glacier Bay motor

### Discussion

The numerical results of the examples are collected in Table III. They reveal the impact of the various parameters. Specifically, lowering the ohmic loss is detrimental through increasing the machine dimensions and cost. This occurs through the accompanying reduction of current density. This point merits some extra discussion, as follows:

For MP-T machines, the current density is limited to ˜1×10⁷ A/m² or up to 1.4×10⁷ A/m², because at still higher current densities, the magnetic poles slip past each other. Accordingly, in previous conceptional designs of MP machines of all types, the current density was generally limited to j˜1×10⁷ A/m². Other types of electric machines may be subject to the same limitation, and in addition, and apparently routinely, are limited on account of cooling. This is not a problem with MP-T machines because of the ease with which they may be cooled. Moreover, on account of the “sleeve” construction, the current density of MP-D machines in accordance with the present invention is not constrained through the maximum torque supportable by the magnet arrangement. Rather, it is believed that given adequately strong mechanical construction, the current density of MP-D machines may be raised indefinitely. If so, the current densities in Table III, reaching up to j=2,740 A/cm², will be easily possible. However, detailed finite element analysis is still needed to verify this point.

The parameter of greatest impact on machine size and power density is K. Regrettably from the stand-point of conceptional machine construction, decreasing K, i.e. decreasing size of the magnet dimensions, raises the macroscopic machine dimensions, i.e. D and L, even while it decreases machine weight and cost. Also, especially with large machines, the assembly of large numbers of permanent magnets of small dimensions will be needed that doubtlessly adds to the manufacturing cost. As a result, for small machines, K may be as low as 0.08 it is believed, while for large machines K=0.2 is believed to be the lower limit.

Table III also reveals a great advantage of MP-D machines, namely that their voltage can be chosen almost at will, namely through the choice of leaf thickness, w. This feature greatly simplifies the construction of slow machines that otherwise might have unduly low machine voltages.

The perhaps greatest advantage of MP-D machines, especially of MP-D I b type, is their capacity for miniaturization that previous MP machine types lacked. In fact, highly favorable MP-D designs are possible for medium-sized and small machines at reasonably fast rotation rates. Table III exemplifies this fact via the wheelchair motors and “Glacier Bay” motors. Their materials cost and power density are believed to be unsurpassed by any other electric machine construction.

No examples have been given for generators but it will be understood that all of the discussed examples and any others apply to motors as well as generators. Also, all of the particulars of design are given by way of example rather than strict rules. None of the examples involved N_{U}, i.e. the number of parallel units into which a machine may be divided, other than unity. N_{U}>1 is readily possible, however, as already indicated, and can on occasion be highly valuable.

Not previously mentioned is the fact that parallel constructions are possible for MP-A and MP-T machines, i.e. machines with stationary current tubes that accept or deliver alternating currents. The corresponding disclosure on MP-T I and MP-T II machines is in process.

Now we turn to a more detailed illustration of aspects of the invention in each drawing.

FIG. 1 shows the detail of one “leaf” in the wall of an MP-D I t machine in length-wise cross section, with current that intermittently traverses return flux material in magnet/conductor assembly 206_{T}. Inner magnet tube 5_{T} moves relative to current tube 206_{T} along interface 37 with velocity vᵣ=(π/60)Dωᵣₚₘ. This figure represents one among many radially oriented leaves, each of which accommodate one current “turn.” The torque-generating current flows from left to right in sections 2(1) and 2(2) between electrically insulated permanent magnet pairs 5(1)/6(1) and 5(2)/6(2), respectively, as shown by arrows labeled “i.” The current returns from right to left in the horizontally shaded current return at top of the figure. On its way between any two consecutive sections 2(n) and 2(n+1), the current must traverse high resistance flux return material (diagonally shaded from top left to bottom right). On that part of its path, in order to prevent as much as possible the generation of opposing torques, the current is guided away from sliding interface 37 and as much as possible parallel to the magnetic flux return lines (compare FIG. 13). This is accomplished by means of resistance barriers 190 and aided by triangular, insulating, non-magnetic inserts on the sides of magnets 5(1) and 5(2), labeled 130.

Besides the indicated intent of leading the current as nearly parallel to the return magnetic flux lines as possible, so as to minimize opposing torque, the magnetic flux return material shall be shaped to minimize the electrical machine resistance through shortening the current path through it. The design of FIG. 1 is meant to do that in accordance with intuitive sense, but detailed modeling will be needed in the future to achieve the twin goals of minimizing opposing torque as well as ohmic resistance. Even so, since the electrical resistivity of flux return material (probably silicon iron) will be about five times higher than copper or the twisted compacted Litz wires of which sections 2(n) as well as the current return may be made, the total ohmic machine resistance is liable to be dominated by the current transits across it. Machines MP-D I b and MP-D II b are designed to avoid this problem (see FIGS. 15 and 16).

In preferred embodiments of MP-D I t machines, fine metal fibers, e.g. of copper and oriented in the desired current flow direction, may be embedded in the flux returns, along the intended current path, so as to lower the machine resistance. In the present drawing, the morphology of the magnets and relative thickness of flux return material approximates “Case 1A” that was found to be the most favorable among the cases previously modeled for MP-T machines (compare FIGS. 10 to 12). However, as discussed in the section “Optimizing Morphology of Current Paths, Magnets and Flux Returns,” Case 3A is much more favorable for MP-D machines. Indicated dimensions are used in the numerical analysis of machine performance. In order to inhibit short-circuits, surfaces at the sliding interface 37 ought to be covered with an insulating coating that preferably has low friction. In an event; preferably interface 37 is lubricated.

FIG. 2 shows the lengthwise cross section through an MP-D I t machine comprising units as in FIG. 1 above, including magnets that are electrically insulated from each other and from their surroundings. Herein magnet tube 5T is firmly bonded to machine axle 10 via supports 29(1) and 29(2) whose size and shape are given herein by way of example. Magnet tube 5_{T} is rotated through the torque generated by passage of current i through sections 2(n), while current tube 206_{T} is stationary. The overall geometry of the current flow is indicated through arrows labeled “i.” Current return 171 is surrounded by optional cooling jacket 40 through which a cooling fluid such as water or oil or an organic fluid is fed by means of inflow 51 and outflow 52. Axle 10, and optionally with it the whole machine, is supported via posts 23(1) and 23(2) and low-friction bearings 35(1) and 35(2) on base plate 19. Again the details of base plate and supports are optional.

Current return end rings 172 (1) and 172(2) are designed to lead the current consecutively through the leaves, each of which accommodates one current “turn.” The current turns are thus arranged “in series” and the voltages generated by magnetic induction in the case of a generator, and supplied from the outside in case of a machine, of consecutive turns are additive. However, optionally, the machine may be subdivided into N_{U} parallel units, namely through providing independent terminals at the beginning and ending leaves of the machine. By means of such sub-units, a single machine may be simultaneously used as independent machines, motors and/or generators, whose voltage is proportional to the number of leaves, i.e. the number of current turns, between their respective terminals.

As in FIG. 1, machine dimensions that are needed in the analysis of machine performance are indicated between arrows.

FIG. 3 shows a portion of a cross section through an MP-D I t machine in position A-A of FIG. 2. The labels have the same meaning as in FIGS. 1 and 2 and the shading is the same, also, except that in FIGS. 1 and 2, consecutive current carrying sections 2(n) are aligned within a single slice, while herein labels 2(n−1), 2(n) and 2(n+1) designate neighboring leaves in the same current carrying, torque producing section 2, namely that intersected by line A-A in FIG. 2. Radial lines in current tube 206_{T}, i.e. in parts 2(n) as well as in current return 171, are electrically insulating boundaries between neighboring leaves, i.e. between neighboring current “turns” (and, throughout, magnets are electrically insulated from each other and their surroundings). D is the diameter of the midline of sections 2(n). The sliding interface between magnet tube 5_{T} and current tube 206_{T} is here envisaged as formed by electrically insulated flat magnets 5(n) that at their edges slide against parts 2(n) and in-between trap lubricant. As previously derived in provisional patent application “MP-T Cooling and Lubrication” (Submitted Jun. 8, 2006) the anticipated effect is smooth low-friction sliding. This construction requires a tolerance of about 0.06% of D between the two sides of the sliding interface and about 0.5 mm gaps between adjoining magnets, so as to accommodate differential thermal expansion. Details of morphology, e.g. relative sizes of components, are adjustable examples.

FIG. 4. illustrates the end-on view (FIG. 4A) and top view (FIG. 4B) of MP-D I machines as in FIGS. 1 to 3 as well as 15. It clarifies the geometry of passing current i from turn to turn, i.e. from “leaf” to “leaf” about the machine circumference. Again, label numbers and shading are the same as in the previous figures. Albeit, in this case the current direction is opposite to that in FIG. 1.

As drawn, the machine is used as a motor (wherein, as already stated, the current flows in the opposite direction from that in FIG. 1). Thus, in the geometry of FIG. 4A at left, with the current supply at the right of the front view of FIG. 4A and the positive terminal connected to leaf 1 in the outer layer of current return end ring 172(1), current i enters the machine through leaf 1 of the current return 171 at its left. At its right end, the current then flows into and through current return ring 172(2) into leaf 1 of the rightmost section 2 of the motor. Still in leaf 1, it then follows the current path indicated in FIG. 1 but in opposite direction until it arrives in section 2(1) at the left end of leaf 1. From there it follows the current path shown in FIG. 1, but in opposite direction, back to current return ring 172(1) but now on its inner part, where it is transferred to leaf 2 of current return 171. This transfer between leaf 1 and leaf 2 is in FIG. 4A indicated by the slightly curved arrow between leaf 1 in the inner layer of current return ring 172(1) and leaf 2 in the outer layer of current return ring 172(1). From here on the current repeats the same path but now in leaf 2, i.e. from the left to the right end of current return 171, from there to and through leaf 2 of current return end ring 172(2) into the rightmost section 2 of leaf 2, on through the successive sections 2(n) back to the inner part of current return ring 172(1) but now in leaf 2, and onto the outer part of leaf 3 in current return ring 172(1). In the configuration of FIG. 4A, this pattern is repeated from leaf to leaf, i.e. from turn to turn, until the current finally arrives in leaf N of current return ring 172(1) and thence to the negative terminal of the current supply. An alternative and probably simpler geometry is shown in FIG. 4B. Herein both current return end rings simply connect radially aligned leaves, but the current return leaves are slanted against the rotation axis, with an offset of one leaf width. As the voltage difference between the first and last leaf can be substantial, in preferred embodiments, the penultimate rather than the last leaf is connected to the “out” terminal, leaving the last leaf (or perhaps even the last tow or more leaves) as an insulating buffer. Further, the machine may be subdivided into N_{U} parallel units through providing, in pre-selected positions, pairs of terminals in lieu of current connections between successive turns. As throughout, all magnets are electrically insulated from their surroundings.

FIG. 5. shows the cross section through part of an MP-D I t machine wall, as in FIG. 1 but, besides cooling jacket 40(1), including a cooling channel 40 (2) passing from end to end of a machine through current conducting, torque producing sections 2(n). Such channels, i.e. penetrating the comparable current conducting, torque producing sections of MP machines, have been analyzed in the invention disclosure “MP-T Cooling and Lubrication” (Submitted Jun. 8, 2006) and found to be very effective. At constant leaf thickness, channels 40(2) will either interrupt leaves and thereby decrease the current flow or, alternatively, in preferred embodiments, room may be made for channels 40(2) through local narrowing of leaf width. Cooling channels 40(2) may be used alone or in conjunction with cooling jackets 40(1). Details in this drawing are widely adjustable and are given as examples rather than firm guidelines.

FIG. 6. illustrates the detail of a leaf in the wall of an MP-D II t machine in length-wise cross section, including current tube 206T, inner and outer magnet tubes 5_{T} and 6_{T}, and barriers 190 that prevent direct electrical contact between successive sections along interfaces 37 and 38, i.e. 2ᵢ(n) and 2ᵢ(n+1) and similarly 2ₒ(n) and 2ₒ(n+1),—the same as in the generally comparable FIG. 1 of an MP-D I t machine. In the present figure, the magnet arrangement is modeled after Case 3A, rather than Case 1A as in FIG. 1. At this point, pending appropriate finite element analysis, Case 3A is believed to be near-optimal for both MP-D I and MP-D II machines (compare FIGS. 10 to 12) and section “Optimizing Morphology of Current Paths, Magnets and Flux Returns.”

Magnet tubes 5T and 6_{T} are rigidly connected at one end (see FIG. 8) and to axle 10, so as to rotate rigidly together. Relative to 206_{T} the magnet tubes move with velocity vᵣ=(π/60)Dωᵣₚₘ across interfaces 37 and 38. In order to prevent incidental electrical contacts across 37 and 38, magnets should be provided with high-resistance layers that preferably also offers good durability and low friction coefficient, and/or interfaces 37 and 38 should be lubricated.

The present figure is broadly comparable to FIG. 1 for MP-D I t machines. However, besides the already indicated presence of two rather than just one magnet tube, and the evident lack of a current return and cooling jacket 40, MP-D II t machines embody a decisively different current path. Specifically, leaves of the current tube 206_{T} of MP-D II t machines are essentially symmetrical about the radial mid-line between magnets 7(n) and 8(n), i.e. the mid-line of flux return material 177. Further, instead of the current being intermittently deflected away from interface 37 but returning to the same side on the path between successive torque-producing sections as in MP-D I t machines, here the current meanders between inner and outer current-carrying, torque-producing sections, i.e. 2ᵢ(n) and 2ₒ(n). As a result, on each transition from the inner to the outer side of any leaf of current tube 206_{T}, the current traverses thickness 2L_{b} of flux return material 177, as indicated by the arrows labeled “i” in this Fig.

A preferred version of the geometry of those transitions is presented in FIG. 7. They are complicated by the fact that mutually insulated currents must cross each other, namely at crossings labeled 192 in this figure, wherein one current moves from the left inside to the right outside of the slice and the other from the right inside to the left outside. In fact, 192 designates barriers parallel to the plane of the drawing, shown in greater detail in FIG. 7, that provide the needed mutual electrical insulation between the current paths, wherein the two current branches pass on opposite sides of barrier 192.

FIG. 7. shows the detail of a preferred construction of an MP-D II t machine, enabling overlapping to- and fro-current paths between neighboring inner and outer sections in a leaf, i.e. from section 2ᵢ(n) to 2ₒ(n+1) and from section 2ₒ(n+1) to 2ᵢ(n) across flux return material 177, while maintaining mutual electrical insulation between those paths.

Insulating barriers 190(1) and 190 (2), that are normal to the rotation axis, are in the equivalent position and perform the same function as barriers 190 in FIGS. 1, 2, 5 and 6, namely to inhibit axial current flow between sections 2ᵢ(n) and 2ᵢ(n+1) and similarly between 2ₒ(n) and 2ₒ(n+1). Insulating barriers 191(n) and 191(n+1) across “sleeve” ends inhibit current flow to and from magnets (that should be independently insulated in any event) as well as current flow into and out of flux return material 177. Radially oriented insulating barriers 192 parallel to the axis, bisect the potential current paths in flux return material 177 within any one leaf. Thereby they establish two mutually insulated, axially oriented current paths across material 177, one behind and one in front of barrier 192 relative to the observer. Finally, tangentially oriented barriers 194(1) to 194(4) delineate the desired mutually insulated current paths from 2ᵢ(n) to 2ₒ(n+1) and 2ₒ(n+1) to 2ᵢ(n) as indicated by the broken arrowed lines marked “i”

FIG. 8. shows the lengthwise cross section through an MP-D II t machine comprising units as in FIG. 6 above. Current tube 206T is stationary. It is centered on axle 10 by means of easily moving bearings 35 at the ends of supports 181 that are attached to structural end (206E) of magnet/conductor assembly 206T. Axle 10, in turn is supported by pillars 23(1) and 23(2) on base-plate 19 and is free to rotate via bearings 35. For the most part, current tube 206_{T}, which is the stator, is from the inside and outside enclosed in a pocket formed by magnet tubes 5_{T} and 6_{T} and thereby independently centered on axle 10. At their left end in this figure, outer and inner magnet tubes 5_{T} and 6_{T}, are rigidly connected through part 180, and together, through supports 29(1) to 29(4), are rigidly connected to axle 10. Therefore, in the motor mode, the torque developed by current i in current tube 206_{T}, is transferred to axle 10 and rotates it. For added mechanical stability, the outside of magnet tube 6_{T} is at its bottom supported by parts 28 fastened to base plate 19 and supplied with low-friction bearings 35. Note that the details of this arrangement are largely optional and herein are given by way of example only.

FIG. 9. illustrates a partial cross section through an MP-D II machine in position AA of FIG. 8. This figure compares to FIG. 3 in relation to FIG. 2, and like it, employs the same shading and labels as in the preceding figures. Again, radial lines between the magnets designate mutually insulated leaves in current tube 206_{T}, i.e. in parts 2ᵢ(n) and 2ₒ(n). D is the diameter of the midline of current tube 206_{T}. And again, sliding interface gaps 37 and 38, between magnet tubes 5_{T} and 6_{T} and the current tube 206_{T}, are preferably shaped with electrically insulated flat magnets 5(n) and 6(n) as indicated. At their edges and centers these flat magnets slide against parts 2ᵢ(n) and 2ₒ(n), respectively, and thereby provide narrow spaces in which lubricant is trapped and from there distributed. The same requirements for differential thermal expansion apply as already indicated in conjunction with FIG. 3. Labels 40(1), 40(2) and 40(3) designate examples for the location of cooling channels, and the inset at bottom left indicates how cooling liquid may be supplied to these via a coolant supply tube 41 and another for draining the coolant, both attached to the end piece 206_{E} of current tube 206_{T} as shown. To this end, cooling channels 40 will preferably make at least one 180° turn inside assembly 206_{T} as shown. This is required because in MP-D II machines, only one end of the current tube is accessible, preventing flow-through cooling as will be possible with MP-D I machines (see FIG. 5). The current transfer from leaf to leaf, i.e. “double turn to double turn” may be accomplished as shown in FIG. 4A. Details are adjustable and here are given by way of example only.

FIG. 10. reveals the basic geometry that was used in finite element analysis of magnetic flux distributions for various cases by Eric Maslen of UVA, and by means of which the flux densities expected from different “sleeve” morphologies have been assessed. Unlike the magnet morphology of MP-D machines, e.g. as in FIGS. 1, 2 and 5, there are no gaps between the magnets and the radial polarity alternates from magnet to magnet in this figure. For neighboring magnets of same polarity, as in FIGS. 1, 2 and 5, however, gaps are needed for “flux return.” It is expected, that this change of morphology does not result in undue changes of magnetic flux density between the magnet pairs, and that, if anything, the flux density is thereby increased. The critical dimensions are the periodicity distance 2Lₘ, the magnet thickness Hₘ, the thickness of the flux return material L_{b}, and the gap width between opposing magnets L_{g}.

FIG. 11. shows the morphology of magnets and field lines (in the manner of FIG. 10, top) and magnetic flux density on mid-line of current conduction, torque-producing sections 2(n) (bottom) for Case 1A according to a finite element analysis by Eric Maslen, UVA, September 2005. While in accordance with FIG. 10, the analysis assumes NdFeB 35MGOe magnet material, 45MGOe magnets will be favorably used in MP-D machines. Correspondingly, the flux densities in the lower part of the figure should be multiplied with the factor of (45/35)^{1/2}=1.13. Thus, pending better modeling, the average magnetic flux density for this Case 1A is expected to be 0.56 tesla instead of 0.49 tesla. Sizes are Hₘ=KHₘₒ=K1.25 cm; L_{b}=Hₘ; Lₘ=KLₘₒ=K2.5 cm, and L_{g}=KL_{go}=K2.5 cm.

FIG. 12. shows the morphology of magnets and field lines and magnetic flux density on mid-line of current conduction, torque-producing sections for Case 3A. On account of using 45MGOe magnets, the average magnetic flux density is expected to be 0.58 tesla instead of 0.51 tesla. Sizes are Hₘ=KHₘₒ=K1.25 cm; L_{b}=Hₘ; Lₘ=KLₘₒ=K7.5 cm, and L_{g}=KL_{go}=K2.5 cm.

FIG. 13. The expected flux density distribution, B, in an MP-D I t machine in accordance with FIG. 1 but utilizing the Case 3A modeling shown in FIG. 12. At this point, before the completion of modeling for optimizing the magnet and flux return material morphology, it appears that a small (e.g. 10% to 20%) volume percentage of highly conductive metal fibers, e.g. of copper, will have to be embedded in the flux return material more or less parallel to the flux lines, as indicated by label 9, in order to avoid significant counter torque. Given such fiber embodiment, and based on this expected pattern, the factor f for the relative torque-producing length of current path (i.e. within sections 2(n)), f L, is assessed at f=0.82. Next, the radial magnetic flux density in sections 2(n) is assessed at B=0.58 tesla (by the use of 45MGOe material instead of the 35 MPOe material modeled in FIG. 12). With these values, and neglecting the probably significant resistance reduction through the discussed embedded fibers, the electrical resistance for one turn is assessed at _{D}R₁=2.3ρL/wT, wherein L is the length of the current tube 206_{T}, w is the slice width, and T is the radial thickness of sections 2(n). Finally, ρ=2×10⁻⁸ Ωm is the expected electrical resistivity in sections 2(n) if made of copper, and the resistivity for the flux return material is taken to be five times larger, i.e. ρ_{F}≅1×10⁻⁷ Ωm (which however, will be greatly reduced by embedded fibers). It should be noted, however, that MP-D I b construction, in which the flux return material bypasses the current (see FIGS. 15 and 16) avoids these problems with apparently little penalty except for locally increased current density.

FIG. 14. compares to FIG. 13 above but for an MP-D II t machine. It is a combination of FIGS. 6 and 12 and clarifies the expected pattern of the magnetic flux density, B, in a section of leaf in an MP-D II t wall for Case 3A. Based on this expected pattern, (i) the factor f for the relative torque-producing length of current path, f L, is assessed at f=0.82, (ii) the radial magnetic flux density within sections 2(n) is assessed at B=0.58 tesla (by the use of 45MGOe material instead of the 35 MPOe material modeled in FIG. 12), and (iii) the electrical resistance for one turn is assessed at _{D}R₁=2.3ρL/wT with L the length of the current tube 206_{T}, w the slice width, T the radial thickness of sections 2(n), and ρ=2×10⁻⁸ Ωm the assumed electrical resistivity of the conductor part of the turn (presumably copper), and five times larger for the flux return material.

Within the limits of accuracy at this point, before the completion of modeling for optimizing the magnet and flux return material morphology, these are the same data as for MP-D I t machines in accordance with FIG. 13 above, provided that in the case of MP-D I t machines, conductive fibers are embedded in the flux return material as indicated in FIG. 13 so as to avoid counter torque. The counter torque problem is lessened or absent in MP-D II t machines because, as shown in this figure, the current is mostly parallel to the flux lines where it will suffer Lorentz forces in axial direction, without impact on the machine behavior, except in the middle of transitions, as in FIG. 7. However, the resulting counter torques from this source will be equal and opposite for the two current branches and therefore will have no net effect.

FIG. 15. shows the wall detail and partial cross sections of MP-D I b machine in the style of FIGS. 1 and 3 of an MP-D I machine of either “t” or “b” type. The crucial difference between MP-D I t and b machines is that in the latter, the current passes along the sliding interface 37 without intermittent deflections away from it in order to avoid intersecting return flux-B that would produce counter torque but in the process must traverse high-resistance flux return material 176. Instead the current is protected from return flux through 2L_{b} wide layers (178) that bypass sect-ion 2(n) leaves on each side, as indicated. Flux return material insertions (178) that bypass the current are inserted only in the gaps between sleeves where they are needed, while they would be detrimental in the current return 171 and the current-carrying, torque-producing sections 2.

FIG. 16. is the top view onto torque-producing inner sections 2(n) of current tube 206_{T} (flattened) showing two different but closely related constructions for bypassing of currents by magnetic flux return material 177 in “bypassing units” 178 of MP-D I b and MP-D II b machines. In figure A at top, the spacing in axial direction between consecutive sections 2(n) and 2(n+1) is made equal to ΔL=2L_{b}, which according to best present modeling is the minimum width of flux return material needed without weakening the magnetic flux density in sections 2(n). In order to provide space for passage of current i through ΔL, the leaf width must then be increased everywhere, i.e. to w*=w+2L_{b}. if w is the chosen current conducting width in units 178. This reduces the number of turns πD/w* in the machine and thereby the machine voltage as well as machine power density. In Fig. B below, the same morphology is used but with lengthened interval ΔL between sections 2(n) and 2(n+1) and therefore slimmed width of bypassing flux return layers. With optimum designs, this will permit overall better machine voltage and power density. The above morphology with just one layer of flux return material between one current conducting layer is the most simple and probably best but is optional, given by way of example only. Multiple layers and/or rods and fibers, with or without twist, are other possible morphologies.

FIG. 17. shows the flux distribution and current path in part of a leaf of an MP-D II b machine. In “bypassing units” 178 (indicated by vertical white stripes) the magnetic flux return bypasses current i (indicated by horizontal arrowed lines) by either of the constructions in FIG. 16 or similar. The cross section of MP-D II machines, cut BB through sleeves, is shown in FIG. 9, being the same for MP-II t and MP-D II b machines. ΔL is the axial extension of units 178. The fraction f of torque-producing current path is f=Lₘₗ/(2Lₘₛ), i.e. is f=Lₘₗ/(Lₘₗ+ΔL). According to present best available modeling, ΔL=2L_{b} is the smallest axial flux return dimension to prevent weakening the magnetic flux density in the torque-producing sections of the current tube. In constructions of bypass units 178 as in FIG. 16A, this requirement results in a widened overall slice width w compared to its narrowest parts in units 178; i.e. to w=w+2L_{b}, whereas constructions as in FIG. 16B uses lengthened ΔL. The choice between these two options will depend on detailed finite element modeling for specific machines. At this time, pending improved finite element analysis, the solution of making ΔL=4Hₘ but the thickness of the flux return material layers in units 178 equal to 2Hₘ, presented in the text, is believed to be optimal.

### Labels for MP-D Machines

| | |
|---|---|
| 2 | current carrying, torque producing section of current tube |
| 2ᵢ | inner current carrying, torque producing section of current tube |
| 2ₒ | outer current carrying, torque producing section of current tube |
| 4 | mid-line of current path in MP-D I or of current tube 206_{T} in MP-D II |
| 5 | inner magnet |
| 5_{T} | inner magnet tube |
| 6 | outer magnet |
| 6_{T} | outer magnet tube |
| 7 | inner magnet in current tube 206_{T} |
| 8 | outer magnet in current tube 206_{T} |
| 9 | implanted or overlaid conductor, mostly copper fibers of copper sheet |
| 10 | axle |
| 19 | machine base plate |
| 23 | mechanical support for axle 10 on machine base plate 19 via low friction bearing 35 |
| 28 | mechanical support of rotating outer magnet tube 6 on base plate 19 via low-friction bearing 35 |
| 29 | rigid mechanical connection between inner magnet tube 5 and axle 10 so as to rotate together |
| 35 | low-friction bearing |
| 37 | sliding interface between current tube 206T and inner magnet tube |
| 38 | sliding interface between current tube 206T and outer magnet tube |
| 40 | cooling jacket or cooling channel |
| 41 | supply or return tube for cooling fluid |
| 130 | non-magnetic insulating material |
| 171 | current return |
| 172 | current return end ring |
| 175 | inner flux return |
| 176 | outer flux return |
| 177 | flux return material between inner and outer magnets in current tube 206_{T} |
| 178 | units in which flux return material bypasses current between adjoining sections of current tube |
| 180 | rigid mechanical connection between outer (5) and inner (6) magnet tube so as to rotate together |
| 181 | mechanical connection centering current tube 206_{T} on axle 10 via bearing 35 |
| 190 | insulating barrier between neighboring sections 2 |
| 191 | insulating barrier across face of magnet sleeve pair and the flux return material 177 between it |
| 192 | radially oriented insulation barrier in flux return material 177 between sleeves in a slice |
| 193 | insulation barrier |
| 194 | circumferentially oriented insulation barrier at edge of flux return material in 206_{T} |
| 206E | Structural end piece of current tube, for attaching part 181 and terminals |
| 206T | Current tube |

This invention may be embodied in other specific forms without departing from the spirit or essential characteristics disclosed. The foregoing embodiments are therefore to be considered in all respects illustrative rather than limiting of the invention described herein. The scope of the invention disclosed is thus indicated by the appended claims rather than by the foregoing description, and all changes which come within the meaning and range of equivalency of the claims are intended to be embraced herein. Unless clearly stated to the contrary, there is no requirement for any particular described or illustrated activity or element, any particular size, speed, dimension, material, or frequency, or any particular interrelationship of any described elements. Therefore, the descriptions and drawings are to be regarded as illustrative in nature and not restrictive. Any information in any material that has been incorporated herein by reference, is only incorporated by reference to the extent that no conflict exists between such information and the statements and drawings set forth herein. In the event of such conflict, including a conflict that will render invalid any claim herein, then any such conflicting information stated to be incorporated by reference is specifically not incorporated by reference herein.

I claim:

1. A direct current electric machine comprising:
two concentric magnet tubes connected at one end and open on the other with a space between; the magnet tubes being fixed to an axle at the central axis of the magnet tubes; each magnet tube further comprising one or more sleeves of one or more magnets;
a current tube in the space between the magnet tubes; said current tube being of substantially constant thickness and comprising one or more magnets in one or more sleeves opposing the one or more magnets in one or more sleeves of both magnet tubes, and a current path between opposing magnets forming one or more turns; all configured so as to produce torque in the same direction as a current passes between any or all sets of opposing magnets.

2. A machine according to claim 1 wherein the machine operates as a motor.

3. A machine according to claim 1 wherein the machine operates as a generator.

4. A machine according to claim 1 wherein the machine operates as a transformer.

5. A machine according to claim 1 wherein each such turn passes the circumferential width between opposing pairs of magnets in the sleeves.

6. A machine according to claim 5 wherein one or more turns further comprise radially extended, mutually electrically insulated conductive leaves.

7. A machine according to claim 1 wherein two or more turns are connected in series.

8. A machine according to claim 1 wherein neighboring magnet sleeves have the same polarity.

9. A machine according to claim 1 wherein neighboring magnet sleeves have different polarity.

10. A machine according to claim 1 wherein neighboring magnet sleeves have a gap between them to accommodate flux return material.

11. A machine according to claim 1 wherein neighboring magnet sleeves have a gap between to accommodate a current path or paths.

12. A machine according to claim 8 wherein neighboring magnet sleeves have a gap between them to accommodate flux return material.

13. A machine according to claim 9 wherein neighboring magnet sleeves have a gap between to accommodate a current path or paths.

14. A machine according to claim 1 wherein the current tube is stationary during the operation of the machine.

15. A machine according to claim 1 wherein the current tube further comprises transits whereby the current is directed along a path from one turn to the next.

16. A machine according to claim 1 wherein the current tube further comprises bypasses whereby the current is directed along a path from one turn to the next.

17. A machine according to claim 1 wherein the magnets of the magnet tubes and current tube are flat.

18. A machine according to claim 1 wherein the magnets of the magnet tubes and current tube are arced.

19. A machine according to claim 1 wherein the machine is cooled by a cooling jacket on the outside of the outermost magnet tube.

20. A machine according to claim 1 wherein the machine is cooled by liquid in the gap or gaps between the magnet tubes and the current tube.

21. A machine according to claim 1 wherein the machine is lubricated by liquid in the gap or gaps between the magnet tubes and the current tube.

22. A machine according to claim 1 wherein the magnet tubes rotate.

23. A direct current electric machine comprising:
a stationary current tube;
two or more magnet tubes further comprising one or more circumferentially arranged magnets into one or more sleeves.

24. A machine according to claim 23 wherein the machine operates as a motor.

25. A machine according to claim 23 wherein the machine operates as a generator.

26. A machine according to claim 23 wherein the machine operates as a transformer.

27. A machine according to claim 23 wherein the current tube further comprises one or more turns, each such turn passing the circumferential width between opposing pairs of permanent magnets in the sleeves.

28. A machine according to claim 23 wherein the current tube is stationary during the operation of the machine.

29. A machine according to claim 23 wherein the current tube further comprises transits whereby the current is directed along a path from one turn to the next.

30. A machine according to claim 23 wherein the current tube further comprises bypasses whereby the current is directed along a path from one turn to the next.

31. A machine according to claim 23 wherein the magnets of the magnet tubes and current tube are flat.

32. A machine according to claim 23 wherein the magnets of the magnet tubes and current tube are arced.

33. A direct current electric machine comprising:
a stationary current tube comprising one or more turns, the current tube being integral to a first stationary magnet tube comprising one or more magnets;
a rotatable second magnet tube comprising one or more magnets.

34. A machine according to claim 33 wherein the second magnet tube is on the outside of the current tube integral to the second magnet tube.

35. A machine according to claim 33 wherein the second magnet tube is on the inside of the current tube integral to the second magnet tube.

36. A machine according to claim 33 wherein the rotatable second magnet tube is fixed to a central axle.

37. A machine according to claim 33 wherein the magnet tubes further comprise one or more magnets arranged into radial sleeves.

38. A machine according to claim 33 wherein the magnets of the first magnet tube oppose the magnets of the second magnet tube.

39. A machine according to claims 33 wherein the magnets are flat.

40. A machine according to claims 33 wherein the magnets are arced.

41. A machine according to claims 33 wherein each turn of the current tube comprise one or more conductive but mutually insulated leaves of circumferential width between opposing pairs of magnets of the first and second magnet tubes.

42. A machine according to claims 33 wherein one or more turns of the current tube are connected in series.

43. A machine according to claim 33 wherein the machine operates as a motor.

44. A machine according to claim 33 wherein the machine operates as a generator.

45. A machine according to claim 33 wherein the machine operates as a transformer.
